(19) United States
(12) Patent Application Publication
(10) Pub. No.: US 2021/0269609 A1
(43) Pub. Date: Sep. 2, 2021

(54) Transfer System For Printing

(71) Applicants: POLICROM SCREENS S.P.A., Bergamo (IT); UNIVERSITA DEGLI STUDI DI MILANO, Milano (IT)

(72) Inventors: Giorgio Vavassori Bisutti, Bergamo (IT); Valentina Sabatini, Como (IT); Hermes Farina, Sorisole (BG) (IT); Marco Ortenzi, Milano (IT); Giuseppe Di Silvestro, Lentate sul Seveso (MB) (IT)

(21) Appl. No.: 17/325,370

(22) Filed: May 20, 2021

Related U.S. Application Data
(62) Division of application No. 16/325,786, filed on Feb. 15, 2019.

(30) Foreign Application Priority Data
Aug. 19, 2016 (IT) 102016000086208

(51) Int. Cl. C08J 7/043; C09D 5/00; C08J 7/04; C09D 11/023; C09D 11/033; C09D 11/102; C09D 11/54

(52) U.S. Cl. CPC C08J 7/043; C09D 5/00; C08J 7/0427; C09D 11/023; C09D 11/033; C08J 2463/00; C09D 11/54; C08J 2367/02; C08J 2371/10; C08J 2377/00; C08J 2381/06; C09D 11/102

(57) ABSTRACT

A process of industrial permeographic printing and textile screen-printing for both hot and cold transfer of a graphic image onto fabric applies, as a coating to a surface on one side of a polymer film, a release or separation/detachment composition of matter. The graphic image is provided using serigraphic inks, both water and solvent based, directly onto the layer of release or separation/detachment composition of matter which coats the polymer film. The inks are placed in contact with the polymeric film coated by the layer of release or separation/detachment composition of matter, said layer bearing the inks which constitute the image on the fabric, the inks being transferred to the fabric as a result of the improved release properties of said inks due to the composition of matter.

This application is a division of U.S. application Ser. No. 16/325,786, filed on Feb. 15, 2019, which is a 371 of PCT/IB2017/054935 filed on Aug. 14, 2017, which claims priority from IT 102016000086208 filed on Aug. 10, 2016.

### FIELD OF INVENTION

This present invention concerns a release or separation/detachment composition of matter to be applied as a coating to the surface area of a polymer film, said composition having a high adhesive capacity, and to polymer substrates where said agent is applied as a coating and to the serigraphic inks printed onto the composition, subject of this invention. When already applied to the polymer film as a layer of coating, it enhances the release or separation/detachment property of these inks, both water-based or solvent-based, on different textile substrates during transfer, either hot and cold, to those fabrics of the graphic image printed on the composition of matter, object of the present invention, in the form of a layer which already coats the polymer film.

The release and separation/detachment composition of matter, according to this present invention, is such that avoids the need for any pretreatment of the polymer film surface and can be applied directly onto the film by means of a single pass in which the composition of matter, according to this present invention, is applied to surface of one side of the polymer film to form a layer of coating using normal polymer film coating technologies such as spreading, for example by means of a Meyer bar, air blade or spray coating.

The polymer film so treated, according to this present invention where the release or separation/detachment composition is applied to its surface on one side, constitutes the matrix which can be used in industrial permeographic printing and textile screen printing for both the hot and cold transfer of a graphic image onto fabric.

At the same time, in fact, the composition of material of the present invention makes it possible to have a high capacity for adhesion to serigraphic inks printed onto it, as well as enhanced release properties of same after their application onto different textile substrates without the need to apply an appropriate compatibilising layer over the release composition, (primer) for the serigraphic inks used.

The image is realised with serigraphic inks, both water and solvent based, directly onto the layer of release or separation/detachment composition of material, of the present invention, which coats the polymer film.

Placing the inks in contact with the polymeric film coated by the layer of release or separation/detachment composition of matter, this layer bearing the inks which constitute the image on the fabric, the inks are transferred to the fabric as a result of the improved release properties of said inks due to the composition matter of the present invention.

### State of the Art

Over the years, different technical solutions and processes have been developed for the sector regarding the modification of the surface properties of polymer films for the purpose of achieving solutions with a high capacity for adhesion to the polymer substrates to which they are applied, at the same time allowing both the serigraphic inks printed onto the substrates to adhere and the improved release properties of the serigraphic inks, themselves. Polymer films which have received a surface treatment therefore act as both ink-receiving films and as polymeric films for the release or separation/detachment of inks.

The primary difficulty, commonly encountered by technicians in the field of reference, is related to surface incompatibility and, therefore, adhesion of the chemical formulations developed for release treatments with the available polymeric supports used as such, and those without any pretreatment with a compatibiliser.

The surface incompatibility and adhesion between the chemical formulation and the non-pretreated polymeric support is due to the difference in tension and free surface energy between the chemical formulation itself and the receptive substrate; a technical problem-solving approach was to modify the wettability properties of the polymer film during extrusion of the polymer itself, or i) incorporating (compound) surface tension modifiers of a polar nature within the polymer matrix or ii) coextrude the polymer film with a second film capable of conferring modified surface properties to the double-layer; in accordance with these technologies are the following examples: i) compounds with polysiloxane and cellulose (JP2008230157 A20081002), polyether imide (JP2014069386 A20140421) and ii) examples of double-layer films with polyethersulfone (JP2000263954 A20000926), or other polymers with high hydrophilic properties (JP2009214483 A20090924, JP2009214471 A20090924, JP2008024850 A20080207, JP2004059861 A20040226, JP2000263952 A20000926, JP09297383 A1997118, JP05345361 A19931227, JP02008228 A19900111, JP02008089 A19900111, JP63207682 A19880829, JP60181382 A19850917, GB2019315 A19791031) in this way achieving high performing polymer films in terms of adhesion of the chemical release treatment but which are expensive from an industrial application point of view.

Another technical resolution related to the modification of the surface tension properties of polymer substrates was developed by electromechanically altering wettability properties of the polymer substrate through specific treatments that promote compatibility and, therefore, surface adhesion between the chemicals elements which are themselves incompatible due to their peculiar surface tension and energy properties.

Specifically, polymer substrates can undergo superficial corona pretreaments (JP09239931 A19970916, JP02194034 A19900731, JP02092589 A19900403) which allow a suitable and solid anchor of the chemical release formulation applied to the polymer film; in any event, this process is not stable over time due to the electrochemical decay of the chemical process itself and, as a consequence, is rarely used on an industrial level.

Polymeric films can also effectively undergo modification of their surface properties by another type of electrochemical pretreatment, plasma treatment (JP62227785 A19871006, JP61130082 A19860617), however this is susceptible to instability over time and chemical decay of pretreatment itself, as is the case with the corona pretreatment. In addition, it is appropriate to emphasise how, at an industrial level, these two types of electrochemical pretreatments are difficult to access and apply to a wide and enlarged scale of production.

A different technical resolution aimed at solving the problem of surface compatibility between the chemical release formulation, and the polymer substrates to which these formulations must be applied, consists of laminating the polymer surface with metal films which are compatible with the surface tension and energy of the chemical formulations (JP06286331 A19941011, JP05345476 A19931227); however, this technology is little used at an industrial level in the sector of reference.

Resolving the problem of incompatibility between the chemical release formulation and polymer substrates has also been pursued through the use of specific and appropriate chemical compatibilisers (primers) applied onto the polymer film through technologies common to the sector, such as the use of a meyer bar air blade or spray, prior to the application of the chemical release formulation, makes it possible to modify the properties of surface wettability of the polymeric substrate to make it chemically suitable and adequate to receive the desired release or separation/detachment chemical formulation and anchor it to the polymer surface.

The use of primers to pretreat the surface of polymer films is a common technological practice in the technical field of reference, despite the significant process input these chemical pretreatments require to resolve the problem of surface incompatibility between the two primary components of the system, i.e.; the chemical release formulation and the polymer substrate. Undoubtedly, their use adds a further process step which prolongs timescales and complicates the methods of preparing the substrates, which are characterised by two machine passes, one relating to the pretreatment of the polymer film surface and one related to the application of the chemical release formulation; for the pretreatment of surfaces, this technology involves the use of thermoplastic resins (JP2002011969 A20020115), rubber based resins (WO2001012448 A120010222, JP2000153676 A20000606), C2-10 dicarboxylic fatty acids (JP08244369 A19960924), acrylic and amine resins (JP08164592 A19960625), polyols (JP07290843 A19951107, JP03248889 A19911106), ester copolymers (JP04220397 A19920811, JP03211089 A19910913, WO9107279 A119910530) and melamine (JP62158040 A19870714) as process compatibilisers.

In addition, this type of process further complicates those processes which already require two steps for the application of the release formulation alone, in addition to surface pre-treatment, as it requires a further surface compatibiliser between the release chemical formulation and the printed ink; a specific example is the process comprising: 1) application of an isocyanate based primer to the polymer film onto which 2) the formulation for release property is applied in a second step, and 3) a third step for the application of a polyol based compatibilising agent for the inks (JP2003053889 A20030226) or for steps 1) and 3) respectively, acrylic resins with oxazolinic groups (JP08011447 A19960116) or metacrylic resins and fluoride base compounds, (JP04103389 A19920406) respectively, acrylic resins and polyols (JP62050193 A19870304) respectively, or sulphuric acids and C14-16 alkyl sulfonated sulfonate compounds (JP61211090 A19860919) respectively, or copolymers of vinyl acetate-vinyl chloride and silicones (GB2143180 A19850206) respectively, or polyurethanes and thermoplastic resins (KR2000042496 A20000715, WO2001003941 A120010118, JP2011230471 A20111117) respectively, or cellulose and acrylic resins (EP 820874 A119980128) respectively, or polysiloxanes and epoxy resins (CN204641119 U20150916) respectively, or cellulose and polyvinyl alcohol and thermoplastic resins (JEP820874 A119980128) respectively.

In some technical processes, the combined use of compatibilising pretreatments of an electrochemical nature and compatibilising pretreatments of a chemical nature are found, resulting in an important contribution to the improved adhesion of the chemical release formulation with the polymer substrate; however, these processes are susceptible to both the decay of the electrochemical treatment and to complication during preparation of the receptor substrate with multi-step processes (CN105346294 A20160224, JP5611193 A19810903).

As regards the chemical nature of the release or separation/detachment formulations available for the technical sector concerned, polysiloxanes are the most commonly used chemical compounds because of their exceptional and effective release properties; however, with respect to the state of the art available, the use of these compounds cannot solve the problems at first bonded to the need to apply a release or separation/detachment chemical formulation that remains adhered to the polymeric substrate itself without having to suitably adapt it during extrusion, or combine it with specific metallic films, or subject it to electrochemical and chemical compatibilisation pretreatments.

In fact, literature for the sector proposes the combined use of polysiloxanes chemical agents and polymer substrates previously modified through extrusion (compound) with surface tension modifiers (JP2012066447 A20120405, US20040126576 A120040701, DE3534100 A119870402); examples are also given for the use of polysiloxanes applied to polymer films laminated with metallic films (JP2007161559 A20070628, JP2001179892 A20010703), or subjected to an electrochemical crown pretreatment (JP01121388 A19890515, U.S. Pat. No. 4,171,397 A19791016).

Numerous processes are also provided where polysiloxanes compounds, for good adhesion to the polymer substrate, are applied following chemical pretreatments in which the compatibilising agents (primer) are acrylic resins (JP2014148646 A20140821, JP63230310 A19880926), amino resins (JP2008156499 A20080710, JP2000080169 A20000321, JP11188813 A19990713, EP413457 A119910220), isocyanates (EP416765 A219910313), vinyl chlorides (JP01198641 A19890810) or polyurethanes (EP202742 A219861126).

Other effective chemical compounds, from the point of view of their release properties, are stearic-based compounds which, like the polysiloxane compounds described above, present notable difficulties related to their poor adhesion to polymer substrates to which they must be applied; even in this instance, compared to the state of the art, the technical solutions adopted consist of modifying the polymer substrate during the extrusion process using surface tension and energy modifiers (WO 200140357 A120010607, BE899496 A119841025, JP2015227418 A20151217, JP201110878 A20110609), or using these release compounds following compatibilising chemical pretreatments using specific primers (WO2014061392 A120140424, JP63202682 A19880822).

Polysiloxanes and stearic based chemical agents are used to a limited extent as release agents. In some processes, silanes are reported to be used as separation/detachment agents to modify the surface properties of polymer films, however, as previously reported for both polysiloxane compounds and those which are stearic based, these compounds require polymer supports which are preventively modified during the extrusion process using surface tension modifiers (JP05025303 A19930202, U.S. Pat. No. 5,169,900 A19921208) or be subjected to chemical compatibilisation pretreaments following extrusion (KR2013052844 A20130523, WO2009067113 A120090528).

There was a strongly felt need to overcome the aforementioned objective limitations with a view to developing a chemical formulation, subject of the present invention, which did not require a preven-five surface pretreatment of the polymer film by either modifying the composition of the polymeric substrate during the process of extrusion (compound) or coextrusion (double layer polymer), or by electrochemical or chemical treatment using specific compatibilisers and surface wettability property correctors, or lastly, through coupling with metallic films, instead permitting an application process characterised by a single machine pass comprising both the properties of adhesion to the polymeric substrate and the sought after release properties, applicable in water and/or solvent based formulations.

In addition, the composition of material of the present invention makes it possible to have a high capacity for adhesion to serigraphic inks printed onto it, as well as enhanced release properties of same after their application onto different textile substrates without the need to apply an appropriate compatibilising layer over the release composition, (primer) for the serigraphic inks used.

Films with surfaces modified according to the present invention can be used effectively, with high performance, in the industrial permeographic printing and textile screen printing sector for the heat transfer of graphic images onto various textile fabrics, achieved through the application of water and solvent based serigraphic inks onto these polymer films, demonstrating satisfactory release properties of the graphic image, whether heat printed or cold printed.

### BRIEF SUMMARY OF THE INVENTION

The requesters, during the course of research in this technical field, created a composition of matter for release and separation/detachment comprising:

A) one or more substances of general formula (I):

PA (I)

where P is a polar head or polar end containing a functional polar group comprising at least one atom selected from oxygen (O) or nitrogen (N) or sulphur (S) and A is an apolar portion comprising at least one Ri aliphatic chain, comprising at least seven carbon atoms, specifically a linear, branched or cyclic aliphatic chain, with or without unsaturations, alkenyl and/or alkynil saturated or unsaturated;

B) a silane or silanes mixtures of general formula:

(RO)ₙ(R¹)₃₋ₙSiR²X (II)

Where X is selected from:

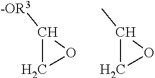

—NH₂, —NCO, —NH—(CH₂)_{y}—NH₂, CH₂═CHCOO—, CH₂═CCH₃COO—, —NH—CO—NH₂, —NH—COO—CH₃, R e R¹, identical or different from one another, are selected from —CH₃, —CH₂CH₃, —CH₂CH₂CH₃ or isopropyl and R is also selected from —COCH₃, —COC₂H₅, —CO-isopropyl, R² and R³, identical or different from one another, are selected from —CH₂—, —(CH₂)₂—, —(CH₂)₃—, n assumes a value selected from 1, 2 and 3, y assumes a value selected from 1, 2, 3, 4, 5 or 6.

In its further embodiments, the composition of release or separation/detachment of the present invention also comprises, in addition to component A), a substance or substances according to general formula (I), and component B), a silane or mixture of silanes according to general formula (II), one or more components selected from:

C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

D) one or more substances or mixtures of substances capable of automatic crosslinking, thermal crosslinking or photo crosslinking, selected from: D1) siloxanic substances of general formula (III) and (IV), as defined below, and/or D2) a system, comprising acrylic substances having acrylic functionality, capable of crosslinking in combination with radical heat or photo initiators suitable for the crosslinking of said acrylic substances;

E) an inorganic load with micrometric and nanometric size particles selected from the group of families comprising silica, carbonate, talc, zeolite, cloisite and montmorillonite or a combination of these, preferably silicas;

F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

The release or separation/detachment composition of matter of the present invention overcomes the problem of difference, and the chemical and physical incompatibility, between the free surface tension and energy of the polymer film and the same release or separation/detachment composition of matter applied as a coating onto said polymer film. This means there is no longer any need for chemical modifications to the polymer film surface through the use of compatibilisers in the polymer film via compounds or coextrusion, physical modifications of the polymer film surface through physical pretreatments such as corona, plasma and lamination, the use of compatibilising primers applied between the release or separation/detachment composition of material applied as a coating and the surface of the polymer film, nor any combinations of the methodologies described above.

The release and separation/detachment composition of matter of the present invention, to be applied as a coating to the surface area of a polymer film, possesses both a high adhesive capacity, and to polymer substrates where said agent is applied as a coating and to the serigraphic inks printed onto the composition, subject of this invention. When already applied to the polymer film as a layer of coating, it enhances the release or separation/detachment property of these inks, both water-based or solvent-based, on different textile substrates during transfer, either hot and cold, to those fabrics of the graphic image printed on the composition of matter, object of the present invention, in the form of a layer which already coats the polymer film.

The release and separation/detachment composition of matter of the present invention is such that avoids the need for any pretreatment of the polymer film surface and can be applied directly onto the film by means of a single pass in which the composition of matter, according to this present invention, is applied to surface of one side of the polymer film to form a layer of coating using normal polymer film coating technologies such as spreading, for example by means of a Meyer bar, air blade or spray technologies.

The polymer film so treated, according to this present invention where the release or separation/detachment composition is applied to its surface on one side, constitutes the matrix which can be used in industrial permeographic printing and textile screen printing for both the hot and cold transfer of a graphic image onto fabric.

At the same time, in fact, the composition of material of the present invention at the same time making it possible to have a high capacity for adhesion to serigraphic inks printed onto it, as well as enhanced release properties of same after their application onto different textile substrates without the need to apply an appropriate compatibilising layer over the release composition, (primer) for the serigraphic inks used.

The image is created using serigraphic inks, both water and solvent based, directly onto the layer of release or separation/detachment composition of material, of this present invention, which coats the polymer film.

Placing the inks in contact with the polymeric film coated by the layer of release or separation/detachment composition of matter, this layer bearing the inks which constitute the image on the fabric, the inks are transferred onto the fabric as a result of the improved release properties of said inks due to the composition matter of the present invention.

A procedure for the preparation of the release or separation/detachment composition of matter constitutes a further subject of the present invention as described here, as well as a polymer film coated with the release or separation/detachment composition of matter of the present invention, as well as the preparation procedure of said coated polymer film.

### BRIEF DESCRIPTION OF THE FIGURES

FIG. 1. This figure shows the stage of preparing the strips of PET polymer film coated with the composition (as was performed for each composition as described in each of the examples, from 1 to 58), according to the present invention, which illustrates the surface areas of the PET polymer film coated with the composition of material, subject of the present invention, from which the test strips were removed in order to determine the release/separation/detachment force.

FIG. 2. Illustration of the test strip preparation stages in order to determine the release/separation/detachment force. A) application of 3M 811 adhesive tape to the surface of the strip of PET polymer film coated with the composition of material of the present invention: formation of the specimen, the polymeric PET film coated with the composition of matter of the invention coupled to the 3M 811 adhesive tape; B) pressure of the tape on the surface of the polymer sample with a 10 kg roll; C) preparation of the specimen to be tested with the adhesive tape part inserted inside the coupling point, fixed jaw grip of the dynamometer and D) with the part of the polymeric film coupled to the spring for dynamometric measurements; E) start of the test.

FIG. 3. Detail showing the position the test strip in the dynamometer (3C) and the start of measuring (3D), which shows the:
a) Dynamometer jaw grip, solidly fixed to the tool and the floor;
b) coupling point of the flap of the 3M tape to the fixed jaw grip;
c) Stripped/unlaminated PET film;
d) Stripped/unlaminated 3M tape;
e) Coupling point of the flap of the PET film to the spring;
f) Spring connected to the moving part of the dynamometer which pulls upwards.

### DETAILED DESCRIPTION OF THE INVENTION

The subject of this present invention therefore constitutes a composition of material of release or separation/detachment comprising:

A) one or more substances of general formula (I):

PA (I)

where P is a polar head or polar end containing a functional polar group comprising at least one atom selected from oxygen (O) or nitrogen (N) or sulphur (S) and A is an apolar portion comprising at least one Rⁱ aliphatic chain, comprising at least seven carbon atoms, specifically a linear, branched or cyclic aliphatic chain, with or without unsaturations, alkenyl and/or alkyl saturated or unsaturated;

B) a silane or silanes mixtures of general formula:

(RO)ₙ(R¹)₃₋ₙSiR²X (II)

Where X is selected from:

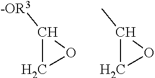

—NH₂, —NCO, —NH—(CH₂)_{y}—NH₂, CH₂═CHCOO—, CH₂═CCH₃COO—, —NH—CO—NH₂, —NH—COO—CH₃, R and R¹, identical or different from one another, are selected from —CH₃, —CH₂CH₃, —CH₂CH₂CH₃ or isopropyl (R also has the substituent —COCH₃, —COC₂H₅, —CO-isopropyl), R² and R³, identical or different from one another, are selected from —CH₂—, —(CH₂)₂—, —(CH₂)₃—, n assumes a value selected from 1, 2 and 3, y assumes a value selected from 1, 2, 3, 4, 5 or 6.

With the P terminal: polar head or tail containing a functional polar group comprising at least one atom selected from oxygen (O) or nitrogen (N) or sulphur (S), of the substance of a general formula (I), according to this present invention, preferably understood as a functional group selected from; HCO—, —COOH, —NH₂, —NH—,

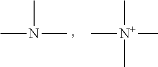

salified with halogen, —CONH₂ o —CONH—,

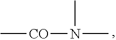

### —NCO, —OH, —SH, —CO—S—, —CO—, —COO—, —NH(CO)O—, —NH(CO)NH₂, —NH(CO)NH—,

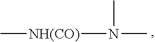

—COO⁻ salified with an alkali metal or alkali earth metal, preferably sodium/potassium, —SO₃⁻ or —OSO₃⁻ salified with an alkali metal or alkali earth metal, preferably sodium/potassium, —C₆H₄—SO₃⁻ salified with an alkali metal or alkali earth metal, preferably sodium/potassium, or the mono-, di- or tri-glycerol reaction derived ester or the mono-, di-, tri- or tetrapentaeritrol reaction derived ester, or the mono- or diethylenediamine reaction derived amide.

According to the present invention the aliphatic chain Rⁱ is a linear, branched or cyclic saturated or unsaturated alkenyl and/or alkynil aliphatic chain with or without unsaturation, comprising at least seven carbon atoms, specifically a linear, branched or cyclic saturated or unsaturated alkenyl and/or alkynil aliphatic chain with or without unsaturation, comprising from 7 to 32 Rⁱ═C7-C32 carbon atoms, preferably selected from a linear, branched or cyclic saturated or unsaturated alkenyl and/or alkynil Rⁱ═C8-C32 aliphatic chain with or without unsaturation, comprising from 8 to 32 carbon atoms, and/or a linear, branched or cyclic saturated or unsaturated alkenyl and/or alkynil Rⁱ═C7-C31 aliphatic chain with or without unsaturation, comprising from 7 to 31 carbon atoms even more preferably selected from a linear, branched or cyclic saturated or unsaturated alkenyl and/or alkynil Rⁱ═C8-C24 aliphatic chain with or without unsaturation, comprising from 8 to 24 carbon atoms, and/or a linear, branched or cyclic saturated or unsaturated alkenyl and/or alkynil Rⁱ═C7-C24 aliphatic chain with or without unsaturation, comprising from 7 to 24 carbon atoms.

In a more preferable preferred embodiment of the release or separation/detachment composition of material of the present invention, the substance or mixtures of substances of a general formula (I) are selected from substances or mixture of substances having a general formula (I′):

P(Rⁱ)ₐ(Rⁱⁱ)_{b} (I′)

in which P is a polar head or tail containing a functional polar group comprising at least one atom selected from oxygen (O) or nitrogen (N) or sulphur (S), as defined above, Rⁱ is a linear, branched or cyclic saturated or unsaturated alkenyl and/or alkynil aliphatic chain with or without unsaturation, comprising at least seven carbon atoms, specifically a linear, branched or cyclic saturated or unsaturated alkenyl and/or alkynil aliphatic chain with or without unsaturation, comprising from 7 to 32 Rⁱ═C7-C32 carbon atoms, preferably selected from a linear, branched or cyclic saturated or unsaturated alkenyl and/or alkynil Rⁱ═C8-C32 aliphatic chain with or without unsaturation, comprising from 8 to 32 carbon atoms, and/or a linear, branched or cyclic saturated or unsaturated alkenyl and/or alkynil Rⁱ═C7-C31 aliphatic chain with or without unsaturation, comprising from 7 to 31 carbon atoms even more preferably selected from a linear, branched or cyclic saturated or unsaturated alkenyl and/or alkynil Rⁱ═C8-C24 aliphatic chain with or without unsaturation, comprising from 8 to 24 carbon atoms, and/or a linear, branched or cyclic saturated or unsaturated alkenyl and/or alkynil Rⁱ═C7-C24 aliphatic chain with or without unsaturation, comprising from 7 to 24 carbon atoms, Rⁱⁱ is selected from the group comprising: a linear, branched or cyclic saturated or unsaturated alkenyl and/or alkynil aliphatic chain with or without saturation, comprising from 1 to 32 carbon atoms: a linear, branched or cyclic saturated or unsaturated alkenyl and/or alkynil Rⁱⁱ═C1-C32 aliphatic chain with or without unsaturation, preferably a linear, branched or cyclic saturated or unsaturated alkenyl and/or alkynil aliphatic chain with or without unsaturation, comprising from 1 to 24 carbon atoms: linear, branched or cyclic saturated or unsaturated alkenyl and/or alkynil Rⁱⁱ═C1-C24 aliphatic chain with or without unsaturation; a group comprising at least 7 carbon atoms selected from alkynilaryl, alkenylaryl, alkinylaryl, arylalkynil, arylalkenyl, arylalkynyl, all substituted or unsubsituted; a group comprising at least 3, 4, 5, 6 or 7 carbon atoms selected from cycloalkynil, cycloalkenyl, cycloalkynyl, all substituted or unsubstituted; or a group comprising at least one 5 or 6-member aromatic or non aromatic and and/or heterocyclic ring containing 0, 1 or 2 heteroatoms selected from nitrogen, oxygen or sulphur, substituted or unsubstituted and (a) is selected from 1, 2, 3 or 4, (b) is selected from 0, 1, 2 or 3 and the sum of (a) and (b) is equal to a value selected from 1, 2, 3 or 4.

According to the present invention, a saturated or unsaturated alkenyl or alkynil aliphatic chains with unsaturation means a chain comprising at least 2 carbon atoms; a saturated or unsaturated alkenyl or alkynil aliphatic chains with or without unsaturations means a chain comprising at least 4 carbon atoms; a branched saturated or unsaturated aliphatic chains means a chain comprising at least 3 carbon atoms, and a cyclic saturated or unsaturated aliphatic chain means a chain comprising at least 3 carbon atoms.

In a more preferable embodiment of the release or separation/detachment composition of material of the present invention, the substance or mixtures of substances of a general formula (I) or general formula (I′) are selected from:
linear, branched or cyclic saturated or unsaturated alkenyl and/or alkyl long-chain Ri=C7-C31 aliphatic carboxylic acids with or without unsaturation, such as: caprylic acid (octanoic acid), pelargonic acid (nonanoic acid), capric acid (decanoic acid), undecanoic acid, lauric acid (dodecanoic acid), tridecanoic acid, myristic acid (tetradecanoic acid), pentadecanoic acid, palmitic acid (hexadecanoic acid), margaric acid (heptadecanoic acid) (octadecanoic acid), nonadecanoic acid, arachidic acid (eicosanoic acid), isonic acidllicyclic acid (lactic acid), tridecanoic acid, myristic acid (tetradecanoic acid, palmitic acid (hexadecanoic acid), margaric acid (heptadecanoic acid), stearic acid (octadecanoic acid), nonadecanoic acid, arachidic acid (eicosanoic acid), isonic acid (docosanoic acid), lignoceric acid), cerotic acid (hexacosanoic acid), montanic acid (octacocanoic acid), melissic acid (triacontanoic acid), laceroic acid (dotriacontanoic acid); cis-9-tetradecenoic acid), sapienic acid (cis-6-hexadecenoic acid), palmitoleic acid (cis-9-hexadecenoic acid), ephedecenoic acid (cis-10-heptadecenoic acid), oleic acid (cis-9-octadecenoic acid), elaidinic acid (trans-9-octadecenoic acid), vaccenic acid or trans-vaccenic acid (trans-11-octadecenoic acid), asclepic acid or cis-vaccenic acid (cis-11-octadecenoic acid) (cis-6-octadecenoic acid), petroselaidic acid (trans-6-octadecenoic acid), gadoleic acid (cis-9-eicosenoic acid), gordic acid (cis-11-eicosenoic acid), cetoleic acid Docosenoic acid), erucic acid (cis-13-docosenoic acid), nicotinic acid (cis-15-tetracosenoic acid); (9,12-octadecatrienoic acid), stearidoic acid (6,9,12,15-octadecatetraenoic acid), arachidonic acid (5,8, 11, 14-eicosatetraenoic acid), timnodonic acid (5,8,11,14,17-eicosapentaenoic acid), clupanodonic acid (5,8,11,14,17-docosapentaenoic acid), cervonic acid (acid 4,7,10, 13,16,19-docosahexaenoic), or their esters such as their mono-, di- or tri-glyceric esters;
aliphatic long-chain amine, primary, secondary or tertiary, having at least one linear, branched or cyclic Rⁱ═C7-C32 aliphatic chain, alkenyl and/or alkinyl saturated and/or unsaturated, with or without saturations, preferably said secondary or tertiary amine having at least one second aliphatic chain which is a linear, branched or cyclic Rⁱⁱ═C1-C32 aliphatic chain, alkenyl and/or alkinyl saturated and/or unsaturated, with or without saturations, such as: aminoethane, aminododecane, aminoundecane, aminododecane, aminotridecane, aminotetradecane, aminopentadecane, aminohexadecane, aminoheptadecane, aminoctadecane, aminononadecane, aminoeicosane, aminodocosane, amino tetracosane, amino octacosane, amino triacontane, amino dotriacontane; aminocis-9-tetradecene, amino cis-6-hexadecene, amino cis-9-hexadecene, amino cis-10-heptadecene, amino cis-9-octadecene, amino trans-9-octadecene, amino trans-11-octadecene, cis-11-octadecene, amino cis-6-octadecene, amino trans-6-octadene amino cis-9-eicosene, amino cis-11-eicosene, amino cis-11-docosene, amino cis-13-docosene, amino cis-15-tetracosene; amino 9,12-octadecadiene, amino 9,12,15-octadecatriene, amino 6,9,12,15-octadecatetraene, amino 5,8,11,14-eicosatetraene, amino 5,8,11,14,17-eicosapentaene, amino 5,8,11,14,17-docosapentaene, amino 4,7,10,13,16,19-docosane;
aliphatic long-chain alcohols having a linear, branched or cyclic, saturated or unsaturated alkenyl and/or alkinyl aliphatic Rⁱ═C7-C32 chain with or without unsaturation, such as: 1-ethanol, 1-octanol, 1-nonanol, 1-decanol, 1-decanol, 1-undecanol, 1-dodecanol, 1-tridecanol, 1-tetradecanol, 1-pentadecanol, 1-hexadecanol, 1-n-heptadecanol, 1-octadecanol, 1-nonadecanol, 1-eicosanol, 1-eneicosanol, 1-docosanol, 1-tricosanol, 1-tetracosanol, 1-hexacosanol, 1-heptacosanol, 1-octacosanol, 1-nonacosanol, 1-triacontanol, 1-entriacontanol, 1-dotriacontanol; 11-undecene-1-ol, (Z)-9-octadecene-1-ol, (E)-9-octadecene-1-ol, (Z,Z)-9,12-octadecadiene-1-ol, (Z,Z,Z)-9,12,15-octadecatriene-1-ol, (Z)-13-docosene-1-ol, (E)-13-docosene-1-ol; 2-methyl-1-pentanol, 2-ethyl-1-hexanol, 2-propyl-1-heptanol, 2-butyl-1-octanol, 2-pentyl-1-nonanol, 2-esyl-1-decanol, 2-heptyl-1-undecanol, 2-octyl-1-dodecanol, 2-nonyl-1-tridecanol, 2-decyl-1-tetradecanol, 2-undecyl-1-pentadecanol, 2-dodecyl-1-hexadecanol, 2-tridecyl-1-heptadecanol, 2-tetradecyl-1-octadecanol; -aliphatic long-chain aldehydes having a linear, branched or cyclic, saturated or unsaturated alkenyl and/or alkinyl aliphatic Rⁱ═C7-C31 chain with or without unsaturation, such as: CH₃(CH₂)₈CHO decanal, CH₃(CH₂)₆CHO octanal, CH₃(CH₂)₁₀CHO dodecanal, CH₃(CH₂)₉CHO undecanal;
aliphatic long-chain ketones having at least one linear, branched or cyclic Rⁱ═C7-C31 aliphatic chain, with or without unsaturations, alkenyl and/or alkinyl saturated or unsaturated, preferably said ketones having a second aliphatic chain bonded to the carbon of the carbonyl group which is a linear, branched or cyclic Rⁱⁱ═C1-C32 aliphatic chain, with or without unsaturations, alkenyl and/or alkinyl saturated or unsaturated, such as: C₁₁H₂₂O 2methyl-3-decanone, CH₃(CH₂)₆COCH₃ 2-nonanone, C₁₄H₂₈O 7ethyl-2methyl-4undecanone, C12H₂₄O isobutyl heptyl ketone, C₁₈H₃₆O 2,6dimethyl-10hexadecanone, C₁₈H₃₆O 5octadecanone;
long-chain isocyanates having a linear or branched or cyclic Ri=C7-C32 aliphatic long-chain, alkenyl and/or alkinyl saturated or unsaturated, with or without unsaturation, such as: hexadecylisocianate, octadecylisocianate;
sulfonates or sulfates of an aliphatic long-chain alkali metal/alkaline earth metal having an Rⁱ═C7-C32 aliphatic chain, such as: hexadecyl sulphate potassium or sodium sulfonate or potassium salts, octadecyl sulphate or sodium sulfonate or potassium salts;
alkyl benzene sulfonates of an aliphatic long-chain alkali metal/alkaline earth metal having one Rⁱ═C7-C32 aliphatic chain, such as: sodium lauryl benzene sulfonate or potassium;
Mono or di-amide derivatives of ethylenediamine reacted with at least one linear or branched C8-C32 aliphatic carboxylic acid with or without unsaturations, alkenyl or alkynyl saturated or unsaturated;
aliphatic long-chain thioalcohols with a linear, branched or cyclic aliphatic Rⁱ═C7-C32 chain, with or without unsaturations, alkenyl and/or alkinyl saturated or unsaturated, such as: CH₃(CH₂)₁₆CH₂SH 1-octadecanethiol, CH₃(CH₂)₆SH 1-heptanethiol, CH₃(CH₂)₁₀CH₂SH 1-dodecanethiol;
aliphatic long-chain carboxylic acid esters with a linear, branched or cyclic Rⁱ═C7-C31 aliphatic chain, with or without unsaturations, alkenyl and/or alkinyl saturated or unsaturated, preferably said esters having a second aliphatic chain bonded to the carbon of the carbonyl group which is a linear, branched or cyclic Rⁱⁱ═C1-C32 aliphatic chain, with or without unsaturations, alkenyl and/or alkinyl saturated or unsaturated, such as:
aliphatic long-chain alcohol esters with a linear, branched or cyclic Rⁱ═C7-C32 aliphatic chain, with or without unsaturations, alkenyl and/or alkinyl saturated or unsaturated, preferably said esters having a second aliphatic chain bonded to the carbon of the carboxyl group which is a linear, branched or cyclic Rⁱⁱ═C1-C32 aliphatic chain, alkenyl or alkinyl saturated or unsaturated with or without unsaturations, such as:
aliphatic long-chain carboxylic acid thioesters with a linear, branched or cyclic Rⁱ═C7-C31 aliphatic chain, with or without unsaturations, alkenyl and/or alkinyl saturated or unsaturated, preferably said thioesters having a second aliphatic chain bonded to the sulphur of the thioester group which is a linear, branched or cyclic Rⁱⁱ═C1-C32 aliphatic chain, with or without unsaturations, alkenyl and/or alkinyl saturated or unsaturated, such as:
aliphatic long-chain thioalcohol thioesters with a linear, branched or cyclic Rⁱ═C7-C32 aliphatic chain, with or without unsaturations, alkenyl and/or alkinyl saturated or unsaturated, preferably said thioesters having a second aliphatic chain bonded to the carbon of the thioester group which is a linear, branched or cyclic Rⁱⁱ═C1-C32 aliphatic chain, with or without unsaturations, alkenyl and/or alkinyl saturated or unsaturated, such as:
primary, secondary or tertiary amides of aliphatic long-chain carboxylic acids having a linear, branched or cyclic Rⁱ═C7-C31 aliphatic chain, with or without unsaturations, alkenyl and/or alkinyl saturated or unsaturated, or secondary or tertiary amides of aliphatic long-chain carboxylic acids having a linear, branched or cyclic Rⁱ═C7-C31 aliphatic chain with or without unsaturations, alkenyl and/or alkinyl saturated or unsaturated, said secondary or tertiary amides having at least one aliphatic chain bonded to the nitrogen of the amide group which is a linear, branched or cyclic Rⁱⁱ═C1-C32 aliphatic chain, with or without unsaturations, alkenyl and/or alkinyl saturated or unsaturated;
secondary or tertiary amides of aliphatic long-chain primary or secondary amines having a linear, branched or cyclic Rⁱ═C7-C32 aliphatic chain, with or without unsaturations, alkenyl and/or alkinyl saturated or unsaturated, preferably said secondary or tertiary amides having a an aliphatic chain bonded to the carbon of the amide group which is a linear, branched or cyclic Rⁱⁱ═C1-C32 aliphatic chain, with or without unsaturations, alkenyl and/or alkinyl saturated or unsaturated;
Aliphatic long-chain quaternary ammonium salts having at least one linear, branched or cyclical Rⁱ═C7-C32 aliphatic chain, with or without unsaturations, alkenyl and/or alkinyl saturated or unsaturated, preferably said ammonium salts having a second linear, branched or cyclical Rⁱⁱ═C1-C32 aliphatic chain, with or without unsaturations, alkenyl and/or alkinyl saturated or unsaturated, such as: distearyl dimethyl ammonium chloride
aliphatic long-chain isocyanate derived urea having a linear, branched or cyclic Rⁱ═C7-C32 aliphatic chain, with or without unsaturations, alkenyl and/or alkinyl saturated or unsaturated, said urea derivatives possibly comprising at least a second aliphatic chain linked to the second nitrogen atom of the urea group, said linear, branched or cyclic Rⁱⁱ═C1-C32 aliphatic chain, with or without unsaturations, alkenyl and/or alkinyl saturated or unsaturated, or aliphatic long-chain primary or secondary amine derived urea having a linear, branched or cyclic Rⁱ═C7-C32 aliphatic chain, with or without unsaturations, alkenyl and/or alkinyl saturated or unsaturated, said urea derivatives comprising a linear, branched or cyclic Rⁱⁱ═C1-C32 aliphatic chain bonded to the second nitrogen atom of the urea group, with or without unsaturations, alkenyl and/or alkinyl saturated or unsaturated;
aliphatic long-chain isocyanate derived carbamates having a linear, branched or cyclic Rⁱ═C7-C32 aliphatic chain, with or without unsaturations, alkenyl and/or alkinyl saturated or unsaturated, said carbamates having at least a second linear, branched or cyclic Rⁱⁱ═C1-C32 aliphatic chain, with or without unsaturations, alkenyl and/or alkinyl saturated or unsaturated, linked to the oxygen of the carbamate group or alcohol derived carbamates having a linear, branched or cyclic Rⁱ═C7-C32 aliphatic chain, with or without unsaturations, alkenyl and/or alkinyl saturated or unsaturated, said carbamates having a second linear, branched or cyclic Rⁱⁱ═C1-C32 aliphatic chain with or without unsaturations, alkenyl and/or alkinyl saturated or unsaturated, bonded to the nitrogen atom of the carbamate group.

The combined use of the of substances of general formula (I), or general formula (I′), and general formula (II) makes it possible to achieve both a chemical composition of matter characterised by high release or separation/detachment properties and by excellent adhesion strength and anchorage to the polymer substrate to which it must be applied. These properties are due to both the individual properties expressed by the substances of general formula (I), or general formula (I′), and general formula (II), and the interaction between these substances and specifically:

i) the substance of general formula (I), or general formula (I′), is characterised by both the presence of a polar head P and at least one linear, branched or cyclic aliphatic Ri long-chain, with or with unsaturations, alkinyl and/or alkenyl saturated or unsaturated, as defined above; this Ri aliphatic chain, in virtue of its apolar nature, ensures exceptional and effective release properties;

ii) the substance of general formula (II) is, at the same time, characterised by: the capacity to promote adhesion of the chemical composition of matter to the polymer substrate to which it is to be applied; correcting and eliminating the difference in surface tension and free energy between the composition of matter, of the present invention, and the polymer substrate to which it is to be applied and the possibility of auto-condensation to create a branched and/or reticulated superstructure capable of anchoring itself with greater tenacity to the polymer substrate;

iii) the substances of general formula (I), or general formula (I′), and general formula (II) are also capable of interacting with each other and establishing polar covalent or covalent P bonds of general formula (I) substance, or general formula (I′), and component —R2X of general formula (II) substance, in this way enhancing the release or separation/detachment properties imparted by the aliphatic Ri chain of general formula (I) substance, or general formula (I′) substance, bonded via the polar head P to the surface of the polymer film by the chemical-physical interaction of general formula (II) substance giving the binary system the characteristics of adhesion to the substrate deriving from its silanoic component.

With regard to the state of the art in the field of reference, the substances from general formula (I), or general formula (I′), and general formula (II), according to the release or separation/detachment composition of matter of the present invention, are utilised in a dependent manner and tightly bonded to each other, and the release or separation/detachment properties of the composition of matter of the present invention are closely correlated to the synergy resulting from the contextual presence/use of both general formula (I) substance, or general formula (I′), and general formula (II) substance: The scientific literature in the field reports the use of substances of general formula (I), or general formula (I′) or general formula (II) individually or separately from one another. The state of the art describes the stand-alone use, individual and independent of each other, or the use of substances from general formula (I), general formula (I′), or general formula (II), neither describing nor suggesting the intention of realising a release or separation/detachment composition of matter which at the same time includes both a substance from general formula (I) or general formula (I′), and a general formula (II) substance, meaning the state of the art does not describe nor suggest the release or separation/detachment composition of the present invention since it does not describe nor suggest the synergistic effect which, at a chemical-physical level, characterises the release or separation/detachment formulations of the present invention. The evidence for this is that the state of the art always describes industrial processes for the production of polymer films with release or separation/detachment properties, or the use of substances from general formula (I), or general formula (I′), or general formula (II) independently of one another, where the polymer film must undergo chemical and/or physical surface pretreatments combined with the use of a compatibilising primer as, for example, resins of an acrylic or amine nature, isocyanates, vinyl chlorides or polyurethanes.

On the contrary, the requesters have developed a composition of matter of the present invention in which the use of substances of general formula (I), or general formula (I′), and general formula (II), as described, in a manner makes it possible to achieve both a chemical composition of matter characterised by high release or separation/detachment properties and by excellent adhesion strength and anchorage to the polymer substrate to which it must be applied. Therefore, this makes it possible to achieve a simplified and economic technological process of application, with respect to those previously noted, which excludes the need for physical and/or chemical pretreatments of the polymer substrates to which it is to be applied and/or the inclusion of further elements which act as compatibilisers with the polymer substrate, itself.

In a preferred embodiment of the release or separation/detachment composition of material of the present invention, the substance or mixtures of general formula (I) or general formula (I′) substances are selected from the group comprising:

a) an long-chain aliphatic carboxylic acid where the head or polar section P is —COOH and the aliphatic chain is a linear, branched or cyclical saturated or unsaturated alkenyl and/or alkyl Rⁱ═C₇-C₃₁ long-chain aliphatic with or without unsaturation, such as: caprylic acid (octanoic acid), pelargonic acid (nonanoic acid), capric acid (decanoic acid), undecanoic acid, lauric acid (dodecanoic acid), tridecanoic acid, myristic acid (tetradecanoic acid), pentadecanoic acid, palmitic acid (hexadecanoic acid), margaric acid (heptadecanoic acid), stearic acid (octadecanoic acid), nonadecanoic acid, arachidic acid (eicosanoic acid), behenic acid (docosanoic acid), lignoceric acid tetracosanoic acid), cerotic acid (hexacosanoic acid), montanic acid (octacocanoic acid), melissic acid (triacontanoic acid), laceroic acid (dotriacontanoic acid); myristoleic acid (cis-9-tetradecenoic acid), sapienic acid (cis-6-hexadecenoic acid), palmitoleic acid (cis-9-hexadecenoic acid), heptadecenoic acid (cis-10-heptadecenoic acid), oleic acid (cis-9-octadecenoic acid), elaidinic acid (trans-9-octadecenoic acid), vaccenic acid or trans-vaccenic acid (trans-11-octadecenoic acid), asclepic acid or cis-vaccenic acid (cis-11-octadecenoic acid) petroselinic acid (cis-6-octadecenoic acid), petroselaidic acid (trans-6-octadecenoic acid), gadoleic acid (cis-9-eicosenoic acid), gondoic acid (cis-11-eicosenoic acid), cetoleic acid (docosenoic acid), nervonic acid (cis-15-tetracosenoic acid), linoleic acid (9,12-octadecadienoic acid), stearidonic acid (6,9,12,15-octadecatetraenoic acid), arachidonic acid (5,8,11, 14-eicosatetraenoic acid), timnodonic acid (5,8,11,14,17-eicosapentaenoic acid), clupanodonic acid (5,8,11,14,17-docosapentaenoic acid), cervonic acid (4,7,10, 13,16,19-docosahexaenoic acid), or an ester of said long-chain aliphatic carboxylic acid, said ester in which the head or polar section P is —COO—, preferably said ester having a second aliphatic chain bonded to the oxygen of the carboxyl group which is a linear, branched or cyclical Rⁱⁱ═C1-C32 aliphatic chain, alkenyl and/or alkinyl saturated or unsaturated, with or without unsaturations, or a thioester of said long-chain aliphatic carboxylic acid, said thioester in which the head or polar section P is —CO—S—, preferably said thioesther having a second aliphatic chain bonded to the sulphur of the thioester group which is a linear, branched or cyclical Rⁱⁱ═C1-C32 chain, alkenyl and/or alkinyl saturated or unsaturated, with or without unsaturations, or a primary, secondary or tertiary amide of said aliphatic long-chain carboxylic acid, said amide in which the head or polar section P is —CONH₂ or —CONH— or

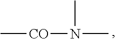

preferably said secondary or tertiary amides having a least one aliphatic chain bonded to the nitrogen of the amide group which is a linear, branched or cyclical Rⁱⁱ═C1-C32 aliphatic chain, alkenyl and/or alkinyl saturated and/or unsaturated, with or without unsaturations;

b) A long-chain aliphatic alcohol in which the head or polar section P is —OH and the aliphatic chain a linear, branched or cyclical Rⁱ═C7-C32 aliphatic chain, alkenyl and/or alkinyl saturated or unsaturated, with or without unsaturation, such as: 1-ethanol, 1-octanol, 1-nonanol, 1-decanol, 1-decanol, 1-undecanol, 1-dodecanol, 1-tridecanol, 1-tetradecanol, 1-pentadecanol, 1-hexadecanol, 1-n-heptadecanol, 1-octadecanol, 1-nonadecanol, 1-eicosanol, 1-heneicosanol, 1-docosanol, 1-tricosanol, 1-tetracosanol, 1-hexacosanol, 1-heptacosanol, 1-octacosanol, 1-nonacosanol, 1-triacontanol, 1-hentriacontanol, 1-dotriacontanol; 11-undecene-1-ol, (Z)-9-octadecene-1-ol, (E)-9-octadecene-1-ol, (Z,Z)-9,12-octadecadiene-1-ol, (Z,Z,Z)-9,12,15-octadecatriene-1-ol, (Z)-13-docosene-1-ol, (E)-13-docosene-1-ol; 2-methyl-1-pentanol, 2-ethyl-1-esanol, 2-propyl-1-eptanol, 2-butyl-1-octanol, 2-pentyl-1-nonanol, 2-esyl-1-decanol, 2-heptyl-1-undecanol, 2-octyl-1-dodecanol, 2-nonyl-1-tridecanol, 2-decyl-1-tetradecanol, 2-undecyl-1-pentadecanol, 2-dodecyl-1-esadecanol, 2-tridecyl-1-eptadecanol, 2-tetradecyl-1-octadecanol or an esters of said long-chain aliphatic alcohol chain, said esters where the head or polar P section is —COO— and the aliphatic chain bonded to the carbon of the carboxyl group is a linear, branched or cyclic Rii=C1-C31 aliphatic chain, alkenyl and/or alkinyl saturated or unsaturated, with or without unsaturations;

c) A primary, secondary or tertiary long-chain aliphatic amine in which the head or polar section P is —NH₂, —NH—

or

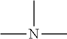

and the aliphatic chain is at least one linear, branched or cyclical Rⁱ═C7-C32 aliphatic chain, alkenyl and/or alkinyl saturated and/or unsaturated, with or without saturations, preferably said secondary or tertiary amine having at least one second aliphatic chain which is a linear, branched or cyclical Rⁱⁱ═C1-C32 aliphatic chain, alkenyl and/or alkinyl saturated and/or unsaturated, with or without saturations, such as: aminoethane, aminododecane, aminoundecane, aminododecane, aminotridecane, aminotetradecane, aminopentadecane, aminohexadecane, aminoheptadecane, aminoctadecane, aminononadecane, aminoeicosane, aminodocosane, amino tetracosane, amino octacosane, amino triacontane, amino dotriacontane; amino-cis-9-tetradecene, amino cis-6-hexadecene, amino cis-9-hexadecene, amino cis-10-heptadecene, amino cis-9-octadecene, amino trans-9-octadecene, amino trans-11-octadecene, cis-11-octadecene, amino cis-6-octadecene, amino cis-9-eicosene, amino cis-11-eicosene, amino cis-11-docosene, amino cis-13-docosene, amino cis-15-tetracosene; amino 9,12-octadecadiene, amino 9,12,15-octadecatriene, amino 6,9,12,15-octadecatetraene, amino 5,8,11,14-eicosatetraene, amino 5,8,11,14,17-eicosapentaene, amino 5,8,11,14,17-docosapentaene, amino 4,7,10,13,16,19-docosane or a secondary or tertiary amide, of said primary or secondary aliphatic long-chain amine, said amide in which the head or polar section P is HCONH—, —CONH— or

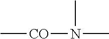

and the aliphatic chain bonded to the carbon of the amide group, where present, is a linear, branched or cyclic alkenyl and or alkynil aliphatic Rⁱⁱ═C₁-C₃₁ chain with or without saturations;

d) An aliphatic long-chain isocyanate in which the polar head or section P is —NCO and the aliphatic chain is a linear, branched or cyclic Rⁱ═C7-C32 aliphatic chain, with or without unsaturations, alkenyl and/or alkinyl saturated or unsaturated, such as: hexadecylisocianate, octadecylisocianate or a urethane derivative (carbamate) of said aliphatic long-chain isocyanate, said urethane derivative in which the polar head or fraction P is —NH(CO)O—, preferably said urethane derivative having a second aliphatic chain bonded to the oxygen of the carbamate group which is a linear, branched or cyclic Rⁱⁱ═C1-C32 aliphatic chain, with or without unsaturations, alkenyl and/or alkinyl saturated or unsaturated, or a ureic derivative of said aliphatic long-chain isocyanate, said ureic derivative in which the polar head or fraction P is —NH(CO)NH₂ or —NH(CO)NH— or

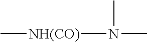

and having at least a second aliphatic chain, bonded to the second nitrogen atom of the ureic group, which is a linear, branched or cyclical Rⁱⁱ═C1-C32 chain, alkenyl and/or alkinyl saturated or unsaturated, with or without saturations;

e) A sulfonate of an aliphatic long-chain alkali metal/alkaline earth metal in which the head or polar section P is SO₃⁻ and the aliphatic chain is an Rⁱ═C7-C32 aliphatic chain, such as: hexadecyl sulfonate sodium or potassium salt, octadecyl sulphate or sodium sulfonate or potassium salt;

f) A sulfate of an aliphatic long-chain alkali metal/alkali earth metal in which the head or polar section P is OSO₃⁻ and the aliphatic chain is an Rⁱ═C7-C32 aliphatic chain, such as: hexadecyl sulfate sodium or potassium salt, octadecyl sulphate or sodium sulfonate or potassium salt;

g) alkyl benzene sulfonates (Rⁱ C₆H₄—SO₃⁻) with an Rⁱ═C7-C32 aliphatic chain in which the polar head P is —C6H₄—SO₃⁻ (example lauryl benzene sodium or potassium sulfonate;

h) A mono-, di-, tri-glycerol reaction ester with, or a mono-, di-, tri-, pentaeritrol reaction derived ester with a linear, branched or cyclic long-chain C8-C32 aliphatic carboxylic acids, alkenyl and/or alkinyl saturated or unsaturated, with or without unsaturations, selected from: caprylic acid (octanoic acid), pelargonic acid (nonanoic acid), capric acid (decanoic acid), undecanoic acid, lauric acid (dodecanoic acid), tridecanoic acid, myristic acid (tetradecanoic acid), pentadecanoic acid, palmitic acid (hexadecanoic acid), margaric acid (heptadecanoic acid) (Octadecanoic acid), nonadecanoic acid, arachidic acid (eicosanoic acid), isonic acidllicyclic acid (lactic acid), tridecanoic acid, myristic acid (Tetradecanoic acid, palmitic acid (hexadecanoic acid), margaric acid (heptadecanoic acid), stearic acid (octadecanoic acid), nonadecanoic acid, arachidic acid (eicosanoic acid), isonic acid (docosanoic acid), lignoceric acid), Cerotic acid (hexacosanoic acid), montanic acid (octacocanoic acid), melissic acid (triacontanoic acid), laceroic acid (dotriacontanoic acid); Cis-9-tetradecenoic acid), sapienic acid (cis-6-hexadecenoic acid), palmitoleic acid (cis-9-hexadecenoic acid), ephedecenoic acid (cis-10-heptadecenoic acid), oleic acid (cis-9-octadecenoic acid), elaidinic acid (trans-9-octadecenoic acid), vaccenic acid or trans-vaccenic acid (trans-11-octadecenoic acid), asclepic acid or cis-vaccenic acid (cis-11-octadecenoic acid) (Cis-6-octadecenoic acid), petroselaidic acid (trans-6-octadecenoic acid), gadoleic acid (cis-9-eicosenoic acid), gordic acid (cis-11-eicosenoic acid), cetoleic acid Docosenoic acid), erucic acid (cis-13-docosenoic acid), nicotinic acid (cis-15-tetracosenoic acid); (9,12-octadecatrienoic acid), stearidoic acid (6,9,12,15-octadecatetraenoic acid), arachidonic acid (5,8, 11, 14-eicosatetraenoic acid), timnodonic acid (5,8,11,14,17-eicosapentaenoic acid), clupanodonic acid (5,8,11,14,17-docosapentaenoic acid), cervonic acid (acid 4,7,10, 13,16,19-docosahexaenoic);

i) An ethylenediamine reaction derived mono- or diamide with at least one linear or branched C8-C32 aliphatic carboxylic acid with or without unsaturations, alkenyl or alkynyl saturated or unsaturated;

j) An aliphatic long-chain quaternary ammonium salt in which the head or polar section P is

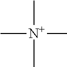

salified with halogen, comprising at least one aliphatic long-chain which is a linear, branched or cyclic Rⁱ═C7-C32 aliphatic chain, with or without unsaturations, alkenyl and/or alkinyl saturated or unsaturated.

In a further preferred embodiment of the release or separation/detachment composition of matter of the present invention, the substance from general formula (I) or general formula (I′) is selected from the group comprising: stearamide, erucamide, oleamide, docosanamide, an ethylenediamine reaction derived mono- or di-amide with at least one linear or branched C8-C24 aliphatic carboxylic acid with or without unsaturations, alkenyl or alkynyl saturated or unsaturated, glycerol reaction derived mono-, di-, or tri-esters reacted with at least one linear, branched or cyclic C8-C24 aliphatic carboxlic acid with or without unsaturations, alkenyl or alkynyl saturated or unsaturated, said linear, branched or cyclic C8-C24 aliphatic carboxylic acid with or without unsaturations, alkenyl or alkynyl saturated or unsaturated selected from: caprylic acid (octanoic acid), pelargonic acid (nonanoic acid), capric acid (decanoic acid), undecanoic acid, lauric acid (dodecanoic acid), tridecanoic acid, myristic acid (tetradecanoic acid), pentadecanoic acid, palmitic acid (hexadecanoic acid), margaric acid (heptadecanoic acid) (Octadecanoic acid), nonadecanoic acid, arachidic acid (eicosanoic acid), isonic acidllicyclic acid (lactic acid), tridecanoic acid, myristic acid (Tetradecanoic acid, palmitic acid (hexadecanoic acid), margaric acid (heptadecanoic acid), stearic acid (octadecanoic acid), nonadecanoic acid, arachidic acid (eicosanoic acid), isonic acid (docosanoic acid), lignoceric acid), Cerotic acid (hexacosanoic acid), montanic acid (octacocanoic acid), melissic acid (triacontanoic acid), laceroic acid (dotriacontanoic acid); Cis-9-tetradecenoic acid), sapienic acid (cis-6-hexadecenoic acid), palmitoleic acid (cis-9-hexadecenoic acid), ephedecenoic acid (cis-10-heptadecenoic acid), oleic acid (cis-9-octadecenoic acid), elaidinic acid (trans-9-octadecenoic acid), vaccenic acid or trans-vaccenic acid (trans-11-octadecenoic acid), asclepic acid or cis-vaccenic acid (cis-11-octadecenoic acid) (Cis-6-octadecenoic acid), petroselaidic acid (trans-6-octadecenoic acid), gadoleic acid (cis-9-eicosenoic acid), gordic acid (cis-11-eicosenoic acid), cetoleic acid Docosenoic acid), erucic acid (cis-13-docosenoic acid), nicotinic acid (cis-15-tetracosenoic acid); (9,12-octadecatrienoic acid), stearidoic acid (6,9,12,15-octadecatetraenoic acid), arachidonic acid (5,8, 11, 14-eicosatetraenoic acid), timnodonic acid (5,8,11,14,17-eicosapentaenoic acid), clupanodonic acid (5,8,11,14,17-docosapentaenoic acid), cervonic acid (acid 4,7,10, 13,16,19-docosahexaenoic).

In a further preferred embodiment of the release or separation/detachment composition of material of the present invention, the silane or mixture of silane of general formula (II) is selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane, or a mixture of them.

The preferred embodiments of the release or separation/detachment composition of material of the present invention comprising a general formula substance (I) or general formula (I′), and a general formula (II) substance may comprise the following:

1) caprylic acid (octanoic acid) or a mono-, di- or triglyceride ester thereof in combination with at least one silane selected from the group consisting of: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

2) pelargonic acid (nonanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

3) capric acid (decanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

4) undecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)₃-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

5) (dodecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)₃-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

6) tridecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)₃-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

7) myristic acid (tetradecanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

8) pentadecanoic acid or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl) 3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

9) palmitic acid (hexadecanoic acid), or one of its mono-, di-, or triglyceride esters in combination with at least one silane selected from the group: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

10) margaric acid (heptadecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

11) stearic acid (octadecanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

12) nonadecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

13) arachidic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)₃-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

14) behenic acid (docosanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

15) lignoceric acid (tetracosanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

16) myristoleic acid (cis-9-tetradecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

17) sapienic acid (cis-6-hexadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

18) palmitoleic acid (cis-9-hexadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

19) heptadecanoic acid (cis-10-heptadecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

20) oleic acid (cis-9-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

21) elaidic acid (trans-9-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

22) vaccenic or trans-vaccenic acid (trans-11-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

23) asclepic acid or cis-vaccenic acid (cis-11-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

24) petroselinic acid (cis-6-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

25) petroselaidic acid (trans-6-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

26) gadoleic acid (cis-9-eicosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

27) gondoic acid (cis-11-eicosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

28) cetoleic acid (cis-11-docosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

29) euric acid (cis-13-docosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

30) nervonoic acid (cis-15-tetracosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

31) linoleic acid (9,12-octadecadienoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

32) α-linolenic acid (9,12,15-octadecatrienic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

33) stearidonic acid (6,9,12,15-octadecatetraenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

34) arachidonic acid (5,8,11,14-eicosatetraenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

35) timnodonic acid (5,8,11,14,17-eicosapentaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

36) clupanodonic acid (5,8,11,14,17-docosapentaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane;

37) cervonoic acid (4,7,10,13,16,19-docosahexaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane.

In its further embodiments, the composition of release or separation/detachment of the present invention comprises, in addition to component A), one or more substances according to general formula (I), or general formula (I′) as described above, and to component B), a silane or mixture of silanes according to general formula (II), as described above, also one or more components selected from the group comprising:

C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

D) one or more substances or mixtures of substances capable of automatic crosslinking, thermal crosslinking or photo crosslinking, selected from the group comprising: D1) siloxanic substances of general formula (III) and (IV), as defined below, and/or D2) a system, comprising acrylic substances having acrylic functionality, capable of crosslinking in combination with radical heat or photo initiators suitable for the crosslinking of said acrylic substances;

E) an inorganic load with micrometric and nanometric size particles selected from the group of families comprising silica, carbonate, talc, zeolite, cloisite and montmorillonite or a combination of these, preferably silicas;

F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

In its further embodiments, the release or separation/detachment composition of material of the present invention comprises, in addition to component A) one or more substances of general formula (I) or general formula (I′) as described above, and to component B) silane or silane mixture according to general formula (II) as described above, also component E) an inorganic load with micrometric and nanometric size particles selected from the group of families comprising silica, carbonate, talc, zeolite, cloisite and montmorillonite or a combination of these, preferably silicas, and/or component F) one or more additives from the dispersal family and/or surface tension moditiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

In its further embodiments, the release or separation/detachment composition of material of the present invention comprises, in addition to component A) one or more substances from general formula (I) or general formula (I′), as described above, and component B) silane or silane mixture from general formula (II), as described above, also component C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides or combinations of these, preferably concerning one or more polar polymers selected from the group comprising the families of polyvinyl alcohols, polyethylene vinyl alcohols, polyvinyl pyrrolidones, cellulose or derivatives of cellulose, more preferably a polymer belonging to the family of: polyvinyl alcohols having a 70% and 100% degree of hydrolysis between, more preferably between 80%-100%; a molecular weight, meaning weight-average molecular weight (Mw), between 10,000 daltons and 250,000 daltons, more preferably between 10,000 daltons and 100,000 daltons; even more preferably polyvinyl alcohols selected from polyvinyl alcohols with an 85%-100% degree of hydrolysis and a molecular weight between of 27,000 daltons and 70,000 daltons, specifically polyvinyl alcohols selected from the group comprising: polyvinyl alcohols with a 98% degree of hydrolysis and a molecular weight of 27,000 daltons (Mowiol®4-98), polyvinyl alcohols with a 98% degree of hydrolysis and molecular weight of 47,000 daltons (Mowiol® 6-98), polyvinyl alcohols with a 98% degree of hydrolysis and molecular weight of 61,000 daltons (Mowiol® 10-98), polyvinyl alcohols with an 88% degree of hydrolysis and molecular weight of 37,000 daltons (Mowiol® 5-88), polyvinyl alcohols with an 88% degree of hydrolysis and molecular weight of 67,000 daltons (Mowiol® 8-88); polyvinyl pyrrolidones selected with a molecular weight between 1,000 daltons and 2,200,000 daltons, more preferably between 1,000 daltons and 450,000 daltons, even more preferably polyvinyl pyrrolidones selected from polyvinyl pyrrolidones with a molecular weight between 1,000 daltons and 60,000 daltons, specifically polyvinyl pyrrolidones with a molecular weight of 4,000 daltons (Plasdone™ K12), 9,000-10,000 daltons (Luvitec® K17, Plasdone™ K17), 34,000 daltons (Plasdone™ K25), 50,000-58,000 Dalton (Luvitec® K30, Plasdone™ K30) and derivatives of cellulose, selected from methyl cellulose, hydroxymethyl cellulose and hydroxypropyl cellulose.

The addition of component C), the polar polymers described above, to the developed composition of matter of the present invention, makes it possible to achieve even greater adhesion of the release or separation/detachment composition of matter to the polymer substrate to which it is applied and makes the embodiments of the present invention more versatile with regard to both the various solvents used for their preparation and application and the various polymer films to which they can be applied.

The polar polymers described above are polymers which have polar groups and their use in the formulation of the present invention makes it possible to more effectively correct any difference in surface tension and free energy between the release or separation/detachment composition of matter and the polymer substrate to which it is to be applied; at the same time it allows the establishment of chemical-physical interactions across the polar groups, including reactives, of these polymers with the substances of general formula (I), or general formula (I′), and general formula (II) of the release or separation/detachment composition of matter, providing the latter with a solid anchor to the polymer film substrate. As previously discussed, the silanolic component of general formula (II) substance is capable of auto-condensation to create branched and/or reticulated superstructures which, when applied, can anchor to the polymer substrate with greater tenacity; the tenacity of this anchorage can vary in relation to the polymer substrate, itself, and to the solvent selected for preparation of the composition of matter to be applied. Specifically, as an example, the effectiveness of the anchorage is in direct proportion to the aggressiveness of the selected solvent towards the polymer film. In fact, an aggressive solvent makes it possible to partially soften the surface of the polymer film, permitting the substance of general formula (II) to come into closer contact with the macromolecules of the polymer film and therefore anchor itself to the film more effectively following auto-condensation in the branched and/or reticulated superstructures. Considering a polyamide or polyester based polymer film, for example, trifluoroacetic acid, di- or tricloroacetic acid based solvents and other halogenated solvents may be considered aggressive, while alcohol or water solvents are slightly aggressive or non-aggressive. For a polyether sulfone (PES) or polyether ether ketone (PEEK) based polymer films, for example, solvents based on dimethyl- or diethylformamide, demethyl- or diethylacetamide, N-methylpyrrolidone and other solvents of a similar chemical nature are considered aggressive, while alcohol or water solvents, in this case, are also slightly aggressive or non-aggressive.

It is understood that a composition comprising substances of general formula (I), or general formula (I′), and general formula (II) and trifluoroacetic acid based or trichloroacetic acid based, possibly in a mixture with other solvents, applied to a polyester or polyamide based film, may permit a better anchorage for system of release or separation/detachment than a composition in which the liquid medium is, for example, a mixture of water and methanol.

Therefore the addition of a polar polymer to the composition, component C) selected from the families described above, together with the substances from general formula (I), or general formula (I′), and general formula (II), components A) and B) respectively, permits industrial choices to be made, such as the use of more or less aggressive, highly versatile solvents; in fact, where the solvent is less aggressive, the anchorage of the release or separation/detachment composition of matter will be supported by the polar polymer present in composition which will contribute to the formation of a stable coating on the surface of the polymeric film.

The embodiments of the composition of release or separation/detachment of the present invention comprises, comprising component A), one or more substances of general formula (I), or general formula (I′) as described above, component B), a silane or mixture of silanes according to general formula (II), as described above, and component C) a polymer of a polar nature, as described above, examples of which follow:

1) caprylic acid (octanoic acid) or a mono-, di- or triglyceride ester thereof in combination with at least one silane selected from the group consisting of: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 67,000 daltons;

2) pelargonic acid (nonanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with methyl cellulose;

3) capric acid (decanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with hydroxypropyl cellulose;

4) undecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above combinations is in turn combined with polyvinyl alcohol with an 88% degree of hydrolysis and a molecular weight of 37,000 daltons;

5) (dodecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above combinations is in turn combined with polyvinyl alcohol with an 98% degree of hydrolysis and a molecular weight of 61,000 daltons;

6) tridecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above combinations is in turn combined with polyvinyl alcohol with an 88% degree of hydrolysis and a molecular weight of 37,000 daltons;

7) myristic acid (tetradecanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 47,000 daltons;

8) pentadecanoic acid or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 31,000 daltons;

9) palmitic acid (hexadecanoic acid), or one of its mono-, di-, or triglyceride esters in combination with at least one silane selected from the group: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27.000 daltons;

10) margaric acid (heptadecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 31,000 daltons;

11) stearic acid (octadecanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27.000 daltons;

12) nonadecanoic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27.000 daltons;

13) arachidic acid, or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 31,000 daltons;

14) behenic acid (docosanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with methyl cellulose;

15) lignoceric acid (tetracosanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 47,000 daltons;

16) myristoleic acid (cis-9-tetradecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 67,000 daltons;

17) sapienic acid (cis-6-hexadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 50,000-58,000 daltons;

18) palmitoleic acid (cis-9-hexadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 47,000 daltons;

19) heptadecanoic acid (cis-10-heptadecanoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with hydroxypropyl cellulose;

20) oleic acid (cis-9-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27,000 daltons;

21) elaidic acid (trans-9-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 50,000-58,000 daltons;

22) vaccenic or trans-vaccenic acid (trans-11-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 34,000 daltons;

23) asclepic acid or cis-vaccenic acid (cis-11-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 34,000 daltons;

24) petroselinic acid (cis-6-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with hydroxypropyl cellulose;

25) petroselaidic acid (trans-6-octadecenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with methyl cellulose;

26) gadoleic acid (cis-9-eicosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 47,000 daltons;

27) gondoic acid (cis-11-eicosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 34,000 daltons;

28) cetoleic acid (cis-11-docosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 9,000-10,000 daltons;

29) euric acid (cis-13-docosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27,000 daltons;

30) nervonoic acid (cis-15-tetracosenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 4,000 daltons;

31) linoleic acid (9,12-octadecadienoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 98% degree of hydrolysis and a molecular weight of 27,000 daltons;

32) α-linolenic acid (9,12,15-octadecatrienic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 31,000 daltons;

33) stearidonic acid (6,9,12,15-octadecatetraenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 34,000 daltons;

34) arachidonic acid (5,8,11,14-eicosatetraenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 9,000-10,000 daltons;

35) timnodonic acid (5,8,11,14,17-eicosapentaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinyl alcohol with an 88% degree of hydrolysis and a molecular weight of 37,000 daltons;

36) clupanodonic acid (5,8,11,14,17-docosapentaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with polyvinylpyrrolidone with a molecular weight of 9,000-10,000 daltons;

37) cervonoic acid (4,7,10,13,16,19-docosahexaenoic acid), or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-aminopropyl triethoxy silane, N-(2-aminoethyl)-3-aminopropylmethyl dimethoxy silane, 3-aminopropyl trimethoxy silane, 3-ureidopropyl trimethoxy silane, 3-glycidoxypropyl trimethoxy silane, 3-glycidoxypropyl triethoxy silane, 3-glycidoxypropyl methyl diethoxy silane, wherein each of the above listed combinations is in turn combined with hydroxypropyl cellulose; In its further embodiments, the release or separation/detachment composition of material of the present invention comprises, in addition to component A) one or more substances of general formula (I) or general formula (I′) as described above, and to component B) silane or silane mixture according to general formula (II) as described above, and component C) a polymer of a polar nature, as described above, also component E) an inorganic load with micrometric and nanometric size particles selected from the group of families comprising silica, carbonate, talc, zeolite, cloisite and montmorillonite or a combination of these, preferably silicas, and/or component F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

The industrial advantage of having greater versatility of being able to use different types of solvents, bound to the composition of the present invention, may be further supported and enhanced in a further embodiment of the release or separation/detachment composition of matter of the present invention comprising components A) and B), as described above, through the addition of component D), in combination or as an alternative to component C) polar polymer, as described above and previously discussed, component D) being one or more substances or mixtures of substances capable of automatic crosslinking and/or thermal crosslinking and/or photo crosslinking selected from the group comprising: D1) siloxanic substances of general formula (III) and (IV), as defined below, and/or D2) a system, comprising acrylic substances having acrylic functionality, capable of crosslinking in combination with radical heat or photo initiators suitable for the crosslinking of said acrylic substances; Due to the automatic crosslinking, thermal crosslinking and photo crosslinking processes involved in the system and spontaneously activated and/or following exposure to heat and/or following UV irradiation, these substances are capable of providing solid and constant adhesion to the polymeric substrate over time, without the onset of any chemical, physical and temporal decay of the treatment, typically observed in crown, plasma and lamination treatments. It is understood that the above aspect renders the release or separation/detachment composition of matter even more versatile and more flexible for use in industrial processes. In the field of silkscreen printing, for example, the market proposes the use of different inks of a differing chemical nature dispersed in different types of solvents, and these inks may be aggressive to the release or separation/detachment treatment achieved with the composition of matter of the present invention; a solid anchorage and stabilisation of the composition through the additional use of substances capable of automatic/thermal and photo crosslinking makes the overall composition highly versatile and able to ensure maximum freedom of industrial choice in terms of application.

Therefore it constitutes a further embodiment of the release or separation/detachment composition of matter of the present invention comprising, in addition to component A), one or more substances of general formula (I), or general formula (I′) as described above, in combination with component B), a silane or mixture of silanes according to general formula (II), as described above, and component C) one or more polar polymers, also component D) one or more substances or mixtures of substances capable of automatic crosslinking, thermal crosslinking or photo crosslinking, selected from the group comprising: D1) siloxanic substances of general formula (III) and (IV), as defined below, and/or D2) a system, comprising acrylic substances having acrylic functionality, capable of crosslinking in combination with radical heat or photo initiators suitable for the crosslinking of said acrylic substances;

As component D) is also an alternative to component C), in its further embodiments, the release or separation/detachment composition of matter of the present invention comprises, in addition to component A), one or more substances of general formula (I), or general formula (I′) as described above, and to component B), a silane or mixture of silanes according to general formula (II), as described above, also component D) one or more substances or mixtures of substances capable of automatic crosslinking, thermal crosslinking or photo crosslinking, selected from the group comprising: D1) siloxanic substances of general formula (III) and (IV), as defined below, and/or D2) a system, comprising acrylic substances having acrylic functionality, capable of crosslinking in combination with radical heat or photo initiators suitable for the crosslinking of said acrylic substances.

Specifically, for substances included in component D) on the present invention, in the case of one or more substances or mixtures of substances capable of automatic crosslinking, thermal crosslinking or photo crosslinking, selected from the group D1) comprising siloxanics, this refers to one or more siloxanic substances or siloxane mixtures of general formula (III):

(R₄O)ₚSi(R₅)_{q}R₆Z (III)

in which R₄ is selected from —CH₃, —CH₂CH₃, —CH₂CH₂CH₃, isopropyl, —CO—C₂H₅, —CO-isopropyl; R₅ is selected from —CH₃, —CH₂CH₃, —CH₂CH₂CH₃ or isopropyl, p is 1, 2 or 3, and q=3-p, R₆ is selected from —CH₂—, —(CH₂)₂—, —(CH₂)₃— and Z is selected from a linear, branched or cyclic C3-C15 aliphatic chain, vinyl group, aromatic groups selected from phenyl, arylalkyl or alkylthio C6-C12 and/or of general formula (IV):

(R₇)ᵣ—Si—(OR₈)₄₋ᵣ (IV)

in which r is 0, 1, 2 o 3, R₈ is selected from —CH3, —CH2CH3, —CH₂CH₂CH₃, isopropyl, —CO—CH3, —CO—C2H5, —CO-isopropyl; R₇ is selected from —CH3, —CH2CH3, —CH₂CH₂CH₃, isopropyl.

Specifically, siloxanic substances from general formula (III) and/or general formula (IV) are selected from tetramethoxy silane, tetraethoxy silane, methyl trimethoxy silane, methyl triethoxy silane, dimethyl dimethoxy silane, trimethyl ethoxy silane, isooctyl trimethoxy silane, isooctyl triethoxy silane, hexadecyl trimethoxy silane, vinyl trimethoxy silane, vinyl trimethoxy silane, vinyl tris (2-methoxy ethoxy) silane, vinyl tris (2-methoxy ethoxy) silane, vinyl triacetoxy silane, (methylmethacryloxy) methylimidazole silane, methacryloxy methyl methoxy silane, methacryloxy methyltriethoxy silane, 3-methacryloxypropyl trimethoxy silane, 3-methacryloxypropyl triacetoxy silane, phenyl triethoxy silane, N-phenylamino trimethoxy silane, capable of automatic crosslinking which is accelerated by a thermal action.

In addition, according to the present invention, for substances included in component D), in the case of one or more substances or mixtures of substances capable of automatic crosslinking, thermal crosslinking or photo crosslinking selected from the group comprising D2) a system comprising automatic crosslinking acrylic substances having acrylic functionality capable of crosslinking in combination with thermal or photo radical initiators suitable for crosslinking said acrylic substances, meaning one or more acrylic substances having acrylic functionality capable of crosslinking from the group comprising acrylates, methacrylates, acrylic acid, methacrylic acid, acrylonitrile, methacrylonitrile in a mixture with multifunctional acrylic substances such as pentaeritrol di/tri/tetra/penta/hexa acrylate or methacrylate, glycerol di/tri acrylate or methacrylate, dipentaeritrol, penta/hexa acrylate or methacrylate or other acrylates with two or more acrylic or methacrylic functionalities. Such substances as component D2) when present in the release or release composition of the present invention are combined with an additional component: thermo or photo radical initiators suitable for crosslinking said acrylic substances, said thermo or radical initiator wells known in the sector of photo and thermal crosslinking of acrylic substances according to component D2) selected from the group consisting of radical initiators that can be activated by thermolysis, such as benzoyl peroxide, 2,2′-azodi (2-methyl butyronitrile), hydroperoxide, azodiisobutyronitrile, peresters And dichloro benzoyl, and radical initiators that can be activated by photolysis, such as acetone, alkyl hypochlorite, alkyl nitrite and benzophenone.

It constitutes a further embodiment of the composition of release or separation/detachment of the present invention comprising, in addition to component A), one or more substances of general formula (I), or general formula (I′) as described above, in combination with component B), a silane or mixture of silanes according to general formula (II), as described above, component C) one or more polar polymers, as described above, component D) one or more substances or mixtures of substances capable of automatic crosslinking, thermal crosslinking or photo crosslinking as described above: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, also component E) an inorganic load with micrometric and nanometric size particles selected from the group of families comprising silica, carbonate, talc, zeolite, cloisite and montmorillonite or a combination of these, preferably silicas and/or component F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

It constitutes a further embodiment of the composition of release or separation/detachment of the present invention comprising, in addition to component A), one or more substances of general formula (I), or general formula (I′) as described above, in combination with component B), a silane or mixture of silanes according to general formula (II), as described above, component D) one or more substances or mixtures of substances capable of automatic crosslinking, thermal crosslinking or photo crosslinking as described above: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, also component E) an inorganic load with micrometric and nanometric size particles selected from the group of families comprising silica, carbonate, talc, zeolite, cloisite and montmorillonite or a combination of these, preferably silicas and/or component F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols.

The applicants have therefore developed a composition of matter of the present invention of separation/detachment or release in which said optional components, polymers with polar functionality and siloxanic or acrylic substances capable of automatic crosslinking and/or thermal crosslinking and/or photo crosslinking permit, as function of the applicational requirements, a lasting, solid and stable coupling of the composition of matter of the present invention of release and separation/detachment in relation to the polymer substrate to which it is to be applied; this application, in addition, may be realised through a single technical step and is independent of the intended use of the treated polymer films; in this way, it is possible to achieve a simplified and economic technological process of application, compared to those already known, which excludes the need for the polymer substrates to undergo physical and/or chemical pretreatments which must be applied and/or the inclusion of further elements which act as compatibilisers between the composition of matter of the present invention of release or separation/detachment and the polymer substrate, itself.

In its further embodiments, the release or separation/detachment composition of matter of the present invention can be modulated as a function of the direct application requirement of the industrial permeographic and serigraphic fabric printing sector which may have two different graphic finishes: a glossy finish and a matt or opaque finish.

In the embodiments of the composition of matter previously described, a largely glossy result is achieved. To achieve a matt or opaque result, in its further embodiments, the release or separation/detachment composition of matter comprises the additional use of an inorganic load with micrometric and nanometric size particles selected from the group of families comprising silica, carbonate, talc, zeolite, cloisite and montmorillonite or a combination of these.

In one of its further embodiments, the release or separation/detachment composition of material of the present invention comprises the use of process additives such as one or more additives from the dispersal family and/or surface tension modifiers used commonly in the industrial sector of reference, and selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions, also used commonly in the industrial sector of reference, selected from the group comprising acrylic resins, metacrylic resins, alginates, natural rubbers, phosphates, cellulose and its derivatives, polysaccharides, mannitols, pectins, glycerines or glycols.

Therefore, the composition of release or separation/detachment of the present invention characterised by comprising at least component A), one or more substances according to general formula (I), or general formula (I′) as described above, and component B), a silane or mixture of silanes according to general formula (II), as described above, said composition selected from the group comprising:

I) release or separation/detachment composition of matter of the present invention comprising: component A), one or more substances according to general formula (I) or general formula (I′) as described above, and component B), a silane or mixture of silanes according to general formula (II), as described above;

II) release or separation/detachment composition of matter comprising: component A), one or more substances according to general formula (I) or general formula (I′) as described above, component B), a silane or mixture of silanes according to general formula (II) as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances.

III) release or separation/detachment composition of matter of the present invention comprising: component A), one or more substances according to general formula (I) or general formula (I′) as described above, and component B), a silane or mixture of silanes according to general formula (II), as described above and component E) an inorganic load with micrometric and nanometric size particles selected from the group of families comprising silica, carbonate, talc, zeolite, cloisite and montmorillonite or a combination of these, preferably silicas; IV) release or separation/detachment composition of matter comprising: component A) a substance or substances according to general formula (I) or general formula (I) as described above, component B) silane or silane mixture according to general formula II), As described above, and the componentf) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols;

V) release or separation/detachment composition of matter comprising: component A) one or more substances according to general formula (I), or general formula (I′) as described above, component B), a silane or mixture of silanes according to general formula (II), as described above, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

VI) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

VII) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component F), one or more additives from the family of dispersers and/or surface tension modifiers and/or one or more additives from the family of emulsions and/or viscosity correctors and/or suspensions, as described above;

VIII) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above; Therefore, the composition of release or separation/detachment of the present invention characterised by comprising at least component A), one or more substances according to general formula (I), or general formula (I′) as described above, and component B), a silane or mixture of silanes according to general formula (II), as described above, and component C) one or more polar polymers, as described above, said composition selected from the group comprising:

IX) release or separation/detachment composition of matter comprising: component A), one or more substances according to general formula (I) or general formula (I′) as described above, component B), a silane or mixture of silanes according to general formula (II) as described above, and component C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

X) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances;

XI) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component E) an inorganic load with micrometric or nanometric size particles, as described above;

XII) release or separation/detachment composition of matter comprising: component A) one or more substances according to general formula (I), or general formula (I′) as described above, component B), a silane or mixture of silanes according to general formula (II), as described above, component C) one or more polar polymers, as described above, and component F) one or more additives from the family of dispersers and/or surface tension modifiers and/or one or more additives from the family of emulsions and/or viscosity correctors and/or suspensions, as described above;

XIII) release or separation/detachment composition of matter comprising: component A) one or more substances according to general formula (I), or general formula (I′) as described above, component B), a silane or mixture of silanes according to general formula (II), as described above, component C) one or more polar polymers, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

XIV) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

XV) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, and component F), one or more additives from the family of dispersers and/or surface tension modifiers and/or one or more additives from the family of emulsions and/or viscosity correctors and/or suspensions, as described above;

XVI) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

The release or separation/detachment composition of matter of the present invention constitutes a further subject of the present invention, in any of the embodiments described above, selected from the group comprising:

i) release or separation/detachment composition of matter of the present invention comprising: component A), one or more substances according to general formula (I) or general formula (I′) as described above, and component B), a silane or mixture of silanes according to general formula (II), as described above;

ii) release or separation/detachment composition of matter comprising: component A), one or more substances according to general formula (I) or general formula (I′) as described above, component B), a silane or mixture of silanes according to general formula (II) as described above, and component C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

iii) release or separation/detachment composition of matter comprising: component A), one or more substances according to general formula (I) or general formula (I′) as described above, component B), a silane or mixture of silanes according to general formula (II) as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances;

iv) release or separation/detachment composition of matter of the present invention comprising: component A), one or more substances according to general formula (I) or general formula (I′) as described above, and component B), a silane or mixture of silanes according to general formula (II), as described above and component E) an inorganic load with micrometric and nanometric size particles selected from the group of families comprising silica, carbonate, talc, zeolite, cloisite and montmorillonite or a combination of these, preferably silicas;

v) release or separation/detachment composition of matter comprising: component A) a substance or substances according to general formula (I) or general formula (I) as described above, component B) silane or silane mixture according to general formula II), As described above, and the component f) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols;

vi) release or separation/detachment composition of matter comprising: component A) one or more substances according to general formula (I), or general formula (I′) as described above, component B), a silane or mixture of silanes according to general formula (II), as described above, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

vii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances;

viii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component E) an inorganic load with micrometric or nanometric size particles, as described above;

ix) release or separation/detachment composition of matter comprising: component A) one or more substances according to general formula (I), or general formula (I′) as described above, component B), a silane or mixture of silanes according to general formula (II), as described above, component C) one or more polar polymers, as described above, and component F) one or more additives from the family of dispersers and/or surface tension modifiers and/or one or more additives from the family of emulsions and/or viscosity correctors and/or suspensions, as described above;

x) release or separation/detachment composition of matter comprising: component A) one or more substances according to general formula (I), or general formula (I′) as described above, component B), a silane or mixture of silanes according to general formula (II), as described above, component C) one or more polar polymers, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

xi) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component F), one or more additives from the family of dispersers and/or surface tension modifiers and/or one or more additives from the family of emulsions and/or viscosity correctors and/or suspensions, as described above;

xiii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

xiv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, and component F), one or more additives from the family of dispersers and/or surface tension modifiers and/or one or more additives from the family of emulsions and/or viscosity correctors and/or suspensions, as described above;

xvi) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above; also when in the form of a solution, dispersion or emulsion, comprising a liquid medium selected from the group comprising water based solvents, water and organic solvents, specifically organic polar solvents or a mixture of these, specifically water and a polar organic polar solvent.

In one of its particularly preferred embodiments of the release or separation/detachment composition of matter of the present invention, in any one of the embodiments described above, when in the form of a solution, dispersion or emulsion, it comprises a liquid medium selected from the group consisting of water as a single solvent, a mixture of solvents such as water and acids, specifically a mixture of water and trichloroacetic acid, water and dichloroacetic acid, and a mixture of water and trifluoroacetic acid or solvents such as dimethylformamide, dimethylacetamide or their mixtures with water or a mixture of solvents such as water and alcohols, specifically water and methanol, water and ethanol or water and isopropanol.

It is therefore possible to diversify the use of the various compatible liquid media with said composition of matter of the present invention in its possible embodiments, and at the same time it is possible to use only an aqueous medium as a dispersing liquid system in one of its particularly preferred embodiments. On one hand, this enhances the versatility of application of the release or separation/detachment composition of matter as a function of the specific production requirement and, on the other hand, it permits an embodiment free from the presence of solvents potentially harmful to both the environment and human health, when there is a specific technological requiremerit or industrial choice; the level of toxicity linked to their use may also be aggravated by possible reactions of degradation of the solvents themselves. For example, trichloroacetic acid is highly corrosive and, in addition to being harmful to humans and the environment, it may also be harmful to certain industrial systems if these are not properly equipped for their use; another example is provided by dimethylformamide and by ureic derivatives which are considered to be toxic for reproduction and one product of its possible degradation is formaldehyde which is a suspected carcinogen and is suspected of causing genetic defects. In addition, in the textile supply chain of the European Community, specific provisions for ecotoxicological requirements for a fabric which is in contact with human skin, for which the processes along its chain become an important factor in making industrial assessments and choices; for example, the Bluesign® system is a reference for the industry.

The release or separation/detachment composition of matter of the present invention, in any of the embodiments described above, is applicable to polymer films of various chemical natures such as polyester, polyamide, polyetherosulfone (PES), polyether ether ketone (PEEK) or mixtures thereof, possibly treated on the side where the formulation of the present invention will not be applied in an antistatic manner to facilitate the processability of the polymer film itself during the stages of unwinding/winding and spreading.

Preferably, the polymer film on which the release or separation/detachment composition of matter of the present invention of the present invention is applied, in any of the embodiments described above, is polyethylene terephthalate (PET).

Therefore, a polymer film coated continuously, or discontinuously, with the release or separation/detachment composition of matter of the present invention constitutes a further subject of the present invention, in any of the embodiments described above, selected from the group comprising:

i) release or separation/detachment composition of matter of the present invention comprising: component A), one or more substances according to general formula (I) or general formula (I′) as described above, and component B), a silane or mixture of silanes according to general formula (II), as described above;

ii) release or separation/detachment composition of matter comprising: component A), one or more substances according to general formula (I) or general formula (I′) as described above, component B), a silane or mixture of silanes according to general formula (II) as described above, and component C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

iii) release or separation/detachment composition of matter comprising: component A), one or more substances according to general formula (I) or general formula (I′) as described above, component B), a silane or mixture of silanes according to general formula (II) as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances.

iv) release or separation/detachment composition of matter of the present invention comprising: component A), one or more substances according to general formula (I) or general formula (I′) as described above, and component B), a silane or mixture of silanes according to general formula (II), as described above and component E) an inorganic load with micrometric and nanometric size particles selected from the group of families comprising silica, carbonate, talc, zeolite, cloisite and montmorillonite or a combination of these, preferably silicas;

v) release or separation/detachment composition of matter comprising: component A) a substance or substances according to general formula (I) or general formula (I) as described above, component B) silane or silane mixture according to general formula II), As described above, and the component F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols;

vi) release or separation/detachment composition of matter comprising: component A) one or more substances according to general formula (I), or general formula (I′) as described above, component B), a silane or mixture of silanes according to general formula (II), as described above, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

vii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances;

viii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component E) an inorganic load with micrometric or nanometric size particles, as described above;

ix) release or separation/detachment composition of matter comprising: component A) one or more substances according to general formula (I), or general formula (I′) as described above, component B), a silane or mixture of silanes according to general formula (II), as described above, component C) one or more polar polymers, as described above, and component F) one or more additives from the family of dispersers and/or surface tension modifiers and/or one or more additives from the family of emulsions and/or viscosity correctors and/or suspensions, as described above;

x) release or separation/detachment composition of matter comprising: component A) one or more substances according to general formula (I), or general formula (I′) as described above, component B), a silane or mixture of silanes according to general formula (II), as described above, component C) one or more polar polymers, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

xi) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component F), one or more additives from the family of dispersers and/or surface tension modifiers and/or one or more additives from the family of emulsions and/or viscosity correctors and/or suspensions, as described above;

xiii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

xiv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, and component F), one or more additives from the family of dispersers and/or surface tension modifiers and/or one or more additives from the family of emulsions and/or viscosity correctors and/or suspensions, as described above;

xvi) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

in which the polymer film is selected from a polyester, polyamide, polyethersolfone (PES) or polyether ether ketone (PEEK) based polymer, preferably polyethylene terephthalate (PET) or mixtures of these.

The release or separation/detachment composition of matter of the present invention, in any of the embodiments described above, is applied in a thin layer, with common techniques such as a meyer bar, air blade or spray, onto polymer film belonging to the families described above, preferably having a grammage between 0.1-10 grams/m² and dried in the presence of ventilation and/or heating, and preferably with heating at a process temperature between 80-160° C.

Therefore, a procedure for the preparation of a polymer film coated continuously, or discontinuously, with the release or separation/detachment composition of matter of the present invention constitutes a further subject of the present invention, in any of the embodiments described above, selected from the group comprising:

i) release or separation/detachment composition of matter of the present invention comprising: component A), one or more substances according to general formula (I) or general formula (I′) as described above, and component B), a silane or mixture of silanes according to general formula (II), as described above;

ii) release or separation/detachment composition of matter comprising: component A), one or more substances according to general formula (I) or general formula (I′) as described above, component B), a silane or mixture of silanes according to general formula (II) as described above, and component C) one or more polar polymers selected from the group of families comprising polyvinyl alcohols, polyethylene vinyl alcohols, polyvinyl pyrrolidones, polyesters, polyamides, polyacrylates, polymethacrylates, chitosans, cellulose and derivatives of cellulose, polysaccharides and their combinations;

iii) release or separation/detachment composition of matter comprising: component A), one or more substances according to general formula (I) or general formula (I′) as described above, component B), a silane or mixture of silanes according to general formula (II) as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances.

iv) release or separation/detachment composition of matter of the present invention comprising: component A), one or more substances according to general formula (I) or general formula (I′) as described above, and component B), a silane or mixture of silanes according to general formula (II), as described above and component E) an inorganic load with micrometric and nanometric size particles selected from the group of families comprising silica, carbonate, talc, zeolite, cloisite and montmorillonite or a combination of these, preferably silicas;

v) release or separation/detachment composition of matter comprising: component A) a substance or substances according to general formula (I) or general formula (I) as described above, component B) silane or silane mixture according to general formula II), As described above, and the component F) one or more additives from the dispersal family and/or surface tension modifiers selected from the group comprising polyesters, polyurethanes, acrylic resins, metacrylic resins, eposidic resins, cellulose resins or alkyd resins, or a mixture of these and/or one or more additives from the family of emulsifiers and/or viscosity correctors and/or suspensions selected from the group comprising acrylic resins, metacrylic resins, alginates, natural rubbers, phosphates, cellulose and its derivatives, polysaccharides, mannitols, pectins, glycerines or glycols;

vi) release or separation/detachment composition of matter comprising: component A) one or more substances according to general formula (I), or general formula (I′) as described above, component B), a silane or mixture of silanes according to general formula (II), as described above, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

vii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component D) one or more substances or mixtures of substances capable of automatic crosslinking, thermal crosslinking or photo crosslinking, selected from the group comprising: D1) siloxanic substances of general formula (III) and (IV), and/or D2) a system, comprising acrylic substances having acrylic functionality, capable of crosslinking in combination with radical heat or photo initiators suitable for the crosslinking of said acrylic substances;

viii) release or separation/detachment composition of matter comprising: component A), one or more substances according to general formula (I) or general formula (I′) as described above, and component B), a silane or mixture of silanes according to general formula (II) as described above, component C) one or more polar polymers, as described above, and component E) an inorganic load with micrometric or nanometric size particles, as described above;

ix) release or separation/detachment composition of matter comprising: component A) one or more substances according to general formula (I), or general formula (I′) as described above, component B), a silane or mixture of silanes according to general formula (II), as described above, component C) one or more polar polymers, as described above, and component F) one or more additives from the family of dispersers and/or surface tension modifiers and/or one or more additives from the family of emulsions and/or viscosity correctors and/or suspensions, as described above;

x) release or separation/detachment composition of matter comprising: component A) one or more substances according to general formula (I), or general formula (I′) as described above, component B), a silane or mixture of silanes according to general formula (II), as described above, component C) one or more polar polymers, component E) an inorganic load with micrometric or nanometric size particles as described above, and component F) one or more additives from the family of dispersers and/or surface tension modifiers and/or one or more additives from the family of emulsions and/or viscosity correctors and/or suspensions, as described above;

xi) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component F), one or more additives from the family of dispersers and/or surface tension modifiers and/or one or more additives from the family of emulsions and/or viscosity correctors and/or suspensions, as described above;

xiii) release or separation/detachment composition of matter comprising: component A), one or more substances according to general formula (I) or general formula (I′) as described above, and component B), a silane or mixture of silanes according to general formula (II) as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

xiv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, and component E), an inorganic load with micometric or nanometric dimensions, as described above;

xv) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, and component F), one or more additives from the family of dispersers and/or surface tension modifiers and/or one or more additives from the family of emulsions and/or viscosity correctors and/or suspensions, as described above;

xvi) release or separation/detachment composition of matter comprising: component A), one or more substances according to general formula (I) or general formula (I′) as described above, and component B), a silane or mixture of silanes according to general formula (II) as described above, component C) one or more polar polymers, as described above, component D) one or more substances or mixtures of substances capable of automatic crosslinking, thermal crosslinking or photo crosslinking, selected from the group comprising: D1) siloxanic substances of general formula (III) and (IV), and/or D2) a system comprising acrylic substances having acrylic functionality, capable of crosslinking in combination with radical heat or photo initiators suitable for the crosslinking of said acrylic substances, as described above, component E) an inorganic load with micrometric or nanometric size particles, as described above, and component F), one or more additives from the family of dispersers and/or surface tension modifiers and/or one or more additives from the family of emulsions and/or viscosity correctors and/or suspensions, as described above;

in which the release or separation/detachment composition of matter, preferably when in the form of a solution, dispersion or emulsion, is applied in a thin layer, with common techniques such as a meyer bar, air blade or spray, onto polymer film belonging selected from a polyester, polyamide, polyethersolfone (PES) or polyether ether ketone (PEEK) based polymer, preferably polyethylenterephthalate (PET) or mixture of these, preferably having a grammage between 0.1-10 grams/m² and dried in the presence of ventilation and/or heating, and preferably with heating at a process temperature between 80-160° C.

With respect to the process of preparation of the release or separation/detachment composition of matter of the present invention, according to any one of the embodiments described above, both with regard to compositions based on component A), a substance or substances of general formula (I) or general formula (I′), as described above, in combination with component B) a silane or mixture of silanes of general formula (II) as described above, and with regard to compositions based on component A) a substance or substances according to general formula (I) or general formula (I′), as described above, in combination with component B) a silane or silane mixture of general formula (II) as described above, and component C) one or more polar polymers, as described above, in all cases the essential components can be combined with each other, operating through the normal mixing/stirring methods in solid/liquid stage, at temperatures between 0° C. and 100° C., preferably between 10° C. and 90° C., in the form of a solution, dispersion or emulsion, comprising a liquid medium selected from the group comprising a water based solvent, water, organic solvent, specifically water and an organic polar solvent, or a mixture of these, specifically water and an organic polar solvent, based on the mutual solubility of the essential components of the compositions of matter involved, in relation to the type of solvent employed, preferably selected from the group consisting of water as the single solvent, a mixture of solvents such as water and acids, specifically a mixture of water and trichloroacetic acid, water and dichloroacetic acid, and a mixture of water and trifluoroacetic acid or solvents such as dimethylformamide, dimethylacetamide or their mixtures with water or a mixture of solvents such as water and alcohols, specifically water and methanol, water and ethanol or water and isopropanol.

With respect to molar ratios between the essential components/substances of the release or separation/detachment composition of matter of the present invention, essential components relating to component A and component B respectively, present in all compositions of the present invention, this molar ratio between components A)/B) ranges from 0.1 to 10, preferably from 0.2 to 5, even more preferably from 0.3 to 3, and in the case of release or separation/detachment composition of matter of the present invention comprising the essential components relating to components A)+B)+C) the weight ratio between component C and the sum of components A) and B) is from 0.05 to 10, preferably from 0.1 to 5, even more preferably from 0.2 to 2.

The following are several examples, representative but no limited, of the release or separation/detachment compositions of matter of the present invention, in which the release or separation/detachment composition of matter are distinguished between those comprising at least components A) and B): release or separation/detachment compositions of matter comprising component A), one or more substances according to general formula (I) or general formula (I′) as described above, and component B), a silane or mixture of silanes of general formula (II) as described above; and the release or separation/detachment compositions of matter characterised by comprising at least components A), B) and C): release or separation/detachment composition of matter comprising: component A) a substance or substances of general formula (I) or general formula (I′), as described above, component B) a silane or mixture of silanes of general formula (II), as described above, and component C) one or more polar polymers selected from the group of families comprising polyvinyl alcohols, polyethylene vinyl alcohols, polyvinyl acetates, polyvinyl pyrrolidones, polyesters, polyamides, polyacrylates, polymethacrylates, chitosans, cellulose and derivatives of cellulose, polysaccharides or their combinations; said compositions of matter which differ from each other through any other components and the type of solvent used. Before application, the formulations can be prepared using different methodologies and then applied using different technologies and in varying amounts onto the different polymeric films; the methods of preparation, the application technologies and amounts applied onto polymer films can be varied without departing from the subject of the invention relating to release or separation/detachment composition of matter.

### EXAMPLES

### Example 1

The release or separation/detachment composition of matter consists of:

1) 0.7 grams of glyceryl monostearate;

2) 0.9 grams of 3-glycidoxypropyltrimethoxysilane;

3) 5.00 grams of trifluoroacetic acid.

The composition is prepared in the following way:

In a 25 cm³ flask with a magnetic rod, place 0.70 g of glyceryl monostearate, 0.90 g of 3-glycidoxypropyltrimethoxysilane and 5.00 g of trifluoroacetic acid. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 2

The release or separation/detachment composition of matter consists of:

1) 0.5 grams of palmitic acid;

2) 0.9 grams of 3-glycidoxypropyltrimethoxysilane;

3) 5.00 grams of trifluoroacetic acid.

The composition is prepared in the following way:

In a 25 cm³ flask with a magnetic rod, place 0.50 g of palmitic acid, 0.90 g of 3-glycidoxypropyltrimethoxysilane and 5.00 g of trifluoroacetic acid. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 3

The release or separation/detachment composition of matter consists of:

1) 0.7 grams of glyceryl monostearate;

2) 0.8 grams of 3-aminopropyltriethoxy silane;

3) 5.00 grams of trifluoroacetic acid.

The composition is prepared in the following way:

In a 25 cm³ flask with a magnetic rod, place 0.70 g of glyceryl monostearate, 0.80 g of 3-aminopropyltriethoxysilane and 5.00 g of trifluoroacetic acid. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 4

The release or separation/detachment composition of matter consists of:

1) 0.5 grams of palmitic acid;

2) 0.8 grams of 3-aminopropyltriethoxy silane;

3) 5.00 grams of trifluoroacetic acid.

The composition is prepared in the following way:

In a 25 cm³ flask with a magnetic rod, place 0.50 g of glyceryl palmitic acid, 0.80 g of 3-aminopropyltriethoxysilane and 5.00 g of trifluoroacetic acid. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 5

The release or separation/detachment composition of matter consists of:

1) 0.7 grams of glyceryl monostearate;

2) 0.9 grams of 3-glycidoxypropyltrimethoxysilane;

3) 2.50 grams of trifluoroacetic acid;

4) 2.50 grams of water.

The composition is prepared in the following way:

In a 25 cm³ flask with a magnetic rod, place 0.70 g of glyceryl monostearate, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 6

The release or separation/detachment composition of matter consists of:

1) 0.5 grams of palmitic acid;

2) 0.9 grams of 3-glycidoxypropyltrimethoxysilane;

3) 2.50 grams of trifluoroacetic acid;

4) 2.50 grams of water.

The composition is prepared in the following way:

In a 25 cm³ flask with a magnetic rod, place 0.50 g of palmitic acid, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 7

The release or separation/detachment composition of matter consists of:

1) 0.7 grams of glyceryl monostearate;

2) 0.8 grams of 3-aminopropyltriethoxy silane;

3) 2.50 grams of trifluoroacetic acid;

4) 2.50 grams of water.

The composition is prepared in the following way:

In a 25 cm³ flask with a magnetic rod, place 0.70 g of glyceryl monostearate, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 8

The release or separation/detachment composition of matter consists of:

1) 0.5 grams of palmitic acid;

2) 0.8 grams of 3-aminopropyltriethoxy silane;

3) 2.50 grams of trifluoroacetic acid;

4) 2.50 grams of water.

The composition is prepared in the following way:

In a 25 cm³ flask with a magnetic rod, place 0.50 g of palmitic acid, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 9

The release or separation/detachment composition of matter consists of:

1) 0.7 grams of glyceryl monostearate;

2) 0.9 grams of 3-glycidoxypropyltrimethoxysilane;

3) 2.50 grams of trichloroacetic acid;

4) 2.50 grams of water.

The composition is prepared in the following way:

In a 25 cm³ flask with a magnetic rod, place 0.70 g of glyceryl monostearate, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 10

The release or separation/detachment composition of matter consists of:

1) 0.5 grams of palmitic acid;

2) 0.9 grams of 3-glycidoxypropyltrimethoxysilane;

3) 2.50 grams of trichloroacetic acid;

4) 2.50 grams of water.

The composition is prepared in the following way:

In a 25 cm³ flask with a magnetic rod, place 0.50 g of palmitic acid, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 11

The release or separation/detachment composition of matter consists of:

1) 0.7 grams of glyceryl monostearate;

2) 0.8 grams of 3-aminopropyltriethoxy silane;

3) 2.50 grams of trichloroacetic acid;

4) 2.50 grams of water.

The composition is prepared in the following way:

In a 25 cm³ flask with a magnetic rod, place 0.70 g of glyceryl monostearate, 0.80 g of 3-aminopropyltriethoxysilane, 2.50 g of trichloroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 12

The release or separation/detachment composition of matter consists of:

1) 0.5 grams of palmitic acid;

2) 0.8 grams of 3-aminopropyltriethoxy silane;

3) 2.50 grams of trichloroacetic acid;

4) 2.50 grams of water.

The composition is prepared in the following way:

In a 25 cm³ flask with a magnetic rod, place 0.50 g of palmitic acid, 0.80 g of 3-aminopropyltriethoxysilane, 2.50 g of trichloroacetic acid and 2.50 g of water. Close the flask, agitate and heat to 45-55° C. in a water bath. The composition is left to agitate at 45°-55° C. for circa 30-40 minutes then cooled to room temperature under agitation.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 13

The release or separation/detachment composition of matter consists of:

1) 0.7 grams of glyceryl monostearate;

2) 0.9 grams of 3-glycidoxypropyltrimethoxysilane;

3) 5.0 grams of water;

4) 0.01 grams of Matexil® DAN dispersing agent.

The composition is prepared in the following way:

In a 25 cm³ flask with a magnetic rod, place 0.70 g of glyceryl monostearate, 0.90 g of 3-glycidoxypropyltrimethoxysilane and 5.0 g of water. Close the flask, agitate and heat to 45-55° C. in a water bath. The composition is left to agitate at 45°-55° C. for circa 30-40 minutes then cooled to room temperature and, under agitation, 0.01 g of dispersing agent is added.

At room temperature, the composition is then applied to a PET based polymer film (side without antistatic treatment), having a surface area of circa 650 cm², using a Mayer rod wound with 0.175 mm diameter LSB wire; the film is then dried in an oven at 140° C. for 1.30 minutes.

### Example 14

The release or separation/detachment composition of matter consists of:

1) 0.7 grams of glyceryl monostearate;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

The composition is prepared in the following way:

In a 25 cm³ flask with a magnetic rod, place 0.70 g of glyceryl monostearate, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 15

The release or separation/detachment composition of matter consists of:

1) 0.5 grams of palmitic acid;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent; The composition is prepared in the following way:

In a 25 cm³ flask with a magnetic rod, place 0.50 g of palmitic acid, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 16

The release or separation/detachment composition of matter consists of:

1) 0.7 grams of glyceryl monostearate;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent; The composition is prepared in the following way:

In a 25 cm³ flask with a magnetic rod, place 0.70 g of glyceryl monostearate, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 17

The release or separation/detachment composition of matter consists of:

1) 0.5 grams of palmitic acid;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent; The composition is prepared in the following way:

In a 25 cm³ flask with a magnetic rod, place 0.50 g of glyceryl palmitic acid, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 18

The release or separation/detachment composition of matter consists of:

1) 0.7 grams of glyceryl monostearate;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.70 g of glyceryl monostearate, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 19

The release or separation/detachment composition of matter consists of:

1) 0.5 grams of palmitic acid;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.50 g of palmitic acid, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 20

The release or separation/detachment composition of matter consists of:

1) 0.7 grams of glyceryl monostearate;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.70 g of glyceryl monostearate, 0.80 g of 3-aminopropyltriethoxysilane, 2.50 g of trifluoroacetic acid and 2.50 g of water. The flask is closed and agitated at room temperature. The composition is left to agitate at room temperature for circa 30-40 minutes; to this, 0.6 g of nano-silica, 0.01 g of dispersing agent and 0.01 antifoam agent are then added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 21

The release or separation/detachment composition of matter consists of:

1) 0.5 grams of palmitic acid;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.50 g of palmitic acid, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 22

The release or separation/detachment composition of matter consists of:

1) 0.7 grams of glyceryl monostearate;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.70 g of glyceryl monostearate, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 23

The release or separation/detachment composition of matter consists of:

1) 0.5 grams of palmitic acid;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.50 g of palmitic acid, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 24

The release or separation/detachment composition of matter consists of:

1) 0.7 grams of glyceryl monostearate;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.70 g of glyceryl monostearate, 0.80 g of 3-aminopropyltriethoxysilane, 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 25

The release or separation/detachment composition of matter consists of:

1) 0.5 grams of palmitic acid;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

The composition is prepared in the following way:

In a 25 cm³ flask with a magnetic rod, place 0.50 g of palmitic acid, 0.80 g of 3-aminopropyltriethoxysilane, 2.50 g of trichloroacetic acid and 2.50 g of water. Close the flask, agilate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 26

The release or separation/detachment composition of matter consists of:

1) 0.7 grams of glyceryl monostearate;

2) 0.9 grams of 3-glycidoxypropyltrimethoxysilane;

3) 5.0 grams of water;

4) 0.6 grams of nano-silica;

5) 0.01 grams of Matexil® DAN dispersing agent;

6) 0.01 grams of Silfoam® SRE antifoam agent;

The composition is prepared in the following way:

In a 25 cm³ flask with a magnetic rod, place 0.70 g of glyceryl monostearate, 0.90 g of 3-glycidoxypropyltrimethoxysilane and 5.0 g of water. The flask is closed, agitated and heated to 50-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. Following 20-30 minutes of agitation, the composition is then applied at room temperature to a PET based polymer film, having a surface area of circa 650 cm², using a Mayer rod wound with 0.175 mm diameter LSB wire; the film is then dried in an oven at 140° C. for 1.30 minutes.

### Example 27

The release or separation/detachment composition of matter consists of:

1) 0.7 grams of glyceryl monostearate;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of polyvinyl alcohol; Mowiol® 4-98;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 28

The release or separation/detachment composition of matter consists of:

1) 0.5 grams of palmitic acid;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of Mowiol® 6-98 polyvinyl alcohol;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 60-70° C. in a water bath. The composition is left to agitate at 60-70° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 29

The release or separation/detachment composition of matter consists of:

1) 0.7 grams of glyceryl monostearate;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of Mowiol® 8-88 polyvinyl alcohol;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 75-85° C. in a water bath. The composition is left to agitate at 75-85° C. for circa 20-30 minutes, then cooled to room temperature under agitation.

In a 25 cm³ flask with a magnetic rod, place 0.70 g of glyceryl monostearate, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 30

The release or separation/detachment composition of matter consists of:

1) 0.5 grams of palmitic acid;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of Mowiol® 10-98 polyvinyl alcohol;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 75-85° C. in a water bath. The composition is left to agitate at 75-85° C. for circa 20-30 minutes, then cooled to room temperature under agitation.

In a 25 cm³ flask with a magnetic rod, place 0.50 g of glyceryl palmitic acid, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final formulation is then applied at room temperature to a PET based polymer film, having a surface area of circa 650 cm², using a Mayer rod wound with 0.175 mm diameter LSB wire; the film is then dried in an oven at 120° C. for 2 minutes.

### Example 31

The release or separation/detachment composition of matter consists of:

1) 0.7 grams of glyceryl monostearate;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 4-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 32

The release or separation/detachment composition of matter consists of:

I) 0.5 grams of palmitic acid;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 6-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 60-70° C. in a water bath. The composition is left to agitate at 60-70° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 33

The release or separation/detachment composition of matter consists of:

1) 0.7 grams of glyceryl monostearate;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 8-88 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 75-85° C. in a water bath. The composition is left to agitate at 75-85° C. for circa 20-30 minutes, then cooled to room temperature under agitation.

In a 25 cm³ flask with a magnetic rod, place 0.70 g of glyceryl monostearate, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 34

The release or separation/detachment composition of matter consists of:

1) 0.5 grams of palmitic acid;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 10-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 75-85° C. in a water bath. The composition is left to agitate at 75-85° C. for circa 20-30 minutes, then cooled to room temperature under agitation.

In a 25 cm³ flask with a magnetic rod, place 0.50 g of palmitic acid, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 35

The release or separation/detachment composition of matter consists of:

1) 0.7 grams of glyceryl monostearate;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 4-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 36

The release or separation/detachment composition of matter consists of:

1) 0.5 grams of palmitic acid;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 4-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 37

The release or separation/detachment composition of matter consists of:

1) 0.7 grams of glyceryl monostearate;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 6-98 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 60-70° C. in a water bath. The composition is left to agitate at 60-70° C. for circa 20-30 minutes then cooled to room temperature under agitation.

In a 25 cm³ flask with a magnetic rod, place 0.70 g of glyceryl monostearate, 0.80 g of 3-aminopropyltriethoxysilane, 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 38

The release or separation/detachment composition of matter consists of:

1) 0.5 grams of palmitic acid;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of Mowiol® 8-88 polyvinyl alcohol;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, agitated and heated to 75-85° C. in a water bath. The composition is left to agitate at 75-85° C. for circa 20-30 minutes, then cooled to room temperature under agitation.

In a 25 cm³ flask with a magnetic rod, place 0.50 g of palmitic acid, 0.80 g of 3-aminopropyltriethoxysilane, 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 39

The release or separation/detachment composition of matter consists of:

1) 0.7 grams of glyceryl monostearate;

2) 0.9 grams of 3-glycidoxypropyltrimethoxysilane;

3) 5.0 grams of water;

4) 0.6 grams of nano-silica;

5) 0.01 grams of Matexil® DAN dispersing agent;

6) 0.01 grams of Silfoam® SRE antifoam agent;

7) 0.70 grams of Mowiol® 4-98 polyvinyl alcohol;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane and 5.0 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 1.30 minutes.

### Example 40

The release or separation/detachment composition of matter consists of:

1) 0.7 grams of glyceryl monostearate;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of polyvinylpyrrolidone (PVP Luvitec® k17);

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is ready to be applied to a polymer film.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 41

The release or separation/detachment composition of matter consists of:

1) 0.5 grams of palmitic acid;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of polyvinylpyrrolidone (PVP Luvitec® k30);

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 42

The release or separation/detachment composition of matter consists of:

1) 0.7 grams of glyceryl monostearate;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of polyvinylpyrrolidone (PVP Luvitec® k17);

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 43

The release or separation/detachment composition of matter consists of:

1) 0.5 grams of palmitic acid;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of polyvinylpyrrolidone (PVP Luvitec® k30);

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of glyceryl palmitic acid, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 44

The release or separation/detachment composition of matter consists of:

1) 0.7 grams of glyceryl monostearate;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k30);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 45

The release or separation/detachment composition of matter consists of:

1) 0.5 grams of palmitic acid;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k17);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 46

The release or separation/detachment composition of matter consists of:

1) 0.7 grams of glyceryl monostearate;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k17);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-aminopropyltriethoxysilane, 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 47

The release or separation/detachment composition of matter consists of:

1) 0.5 grams of palmitic acid;

2) 0.8 grams of 3-aminopropyltriethoxy silane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k30);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.80 g of 3-aminopropyltriethoxysilane, 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is ready to be applied to a polymer film.

At room temperature, the composition is then applied to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 48

The release or separation/detachment composition of matter consists of:

1) 0.7 grams of glyceryl monostearate;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k30);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 49

The release or separation/detachment composition of matter consists of:

1) 0.5 grams of palmitic acid;

2) 0.9 grams of 3-glycidoxypropyltrimethoxysilane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k30);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 50

The release or separation/detachment composition of matter consists of:

I) 0.7 grams of glyceryl monostearate;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k30);

9) 0.06 grams of methyl trimethoxy silane;

10) 0.06 grams of methyl triethoxy silane; II) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.80 g of 3-aminopropyltriethoxysilane, 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 51

The release or separation/detachment composition of matter consists of:

1) 0.5 grams of palmitic acid;

2) 0.8 grams of 3-aminopropyltriethoxy silane;

3) 2.50 grams of trichloroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of polyvinylpyrrolidone (PVP Luvitec® k17);

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.80 g of 3-aminopropyltriethoxysilane, 2.50 g of trichloroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following ID15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 52

The release or separation/detachment composition of matter consists of:

1) 0.7 grams of glyceryl monostearate;

2) 0.9 grams of 3-glycidoxypropyltrimethoxysilane;

3) 5.0 grams of water;

4) 0.6 grams of nano-silica;

5) 0.01 grams of Matexil® DAN dispersing agent;

6) 0.01 grams of Silfoam® SRE antifoam agent;

7) 0.70 grams of polyvinylpyrrolidone (PVP Luvitec® k30);

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of polyvinyl alcohol, 0.06 g of methyl trimethoxy silane, 0.06 g of methyl triethoxy silane and 3.0 g of water. The flask is closed, set to agitate and heated to 45-55° C. The composition is left to agitate at 45-55° C. for circa 20-30 minutes; the composition is then cooled to room temperature under agitation.

In a 25 cm³ flask with a magnetic rod, place 0.70 g of glyceryl monostearate, 0.90 g of 3-glycidoxypropyltrimethoxysilane and 5.0 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of polyvinyl alcohol and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 140° C. for 1.30 minutes.

### Example 53

The release or separation/detachment composition of matter consists of:

1) 0.7 grams of glyceryl monostearate;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of methyl cellulose;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of methyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of methyl cellulose and silane is added to the composition. Following 10-15 minutes of agitation, the final composition is ready to be applied to a polymer film.

At room temperature, the composition is then applied to a PET based polymer film, having a surface area of circa 650 cm², using a Mayer rod wound with 0.175 mm diameter LSB wire; the film is then dried in an oven at 120° C. for 2 minutes.

### Example 54

The release or separation/detachment composition of matter consists of:

1) 0.5 grams of palmitic acid;

2) 0.9 grams of 3-glycidoxypropyltrimethoxysilane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of methyl cellulose;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of methyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of methyl cellulose and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

### Example 55

The release or separation/detachment composition of matter consists of:

1) 0.7 grams of glyceryl monostearate;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of hydroxypropyl cellulose;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of hydroxypropyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of hydroxypropyl cellulose and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 56

The release or separation/detachment composition of matter consists of:

1) 0.5 grams of palmitic acid;

2) 0.8 grams of 3-aminopropyltriethoxy silane;

3) 5.00 grams of trifluoroacetic acid;

4) 0.6 grams of nano-silica;

5) 0.01 grams of Matexil® DAN dispersing agent;

6) 0.01 grams of Silfoam® SRE antifoam agent;

7) 0.70 grams of methyl cellulose;

8) 0.06 grams of methyl trimethoxy silane;

9) 0.06 grams of methyl triethoxy silane;

10) 3.0 grams of water

The composition is prepared in the following way:

In a 25 cm³ flask with a magnetic rod, place 0.70 g of methyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of glyceryl palmitic acid, 0.80 g of 3-aminopropyltriethoxysilane and 5.00 g of trifluoroacetic acid. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of methyl cellulose and silane is added to the composition. Following 10-15 minutes of agitation, the final composition is then applied at room temperature to a PET based polymer film (side without antistatic treatment), having a surface area of circa 650 cm², using a Mayer rod wound with 0.175 mm diameter LSB wire; the film is then dried in an oven at 120° C. for 2 minutes.

### Example 57

The release or separation/detachment composition of matter consists of:

1) 0.7 grams of glyceryl monostearate;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of hydroxypropyl cellulose;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of hydroxypropyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.70 g of glyceryl monostearate, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of hydroxypropyl cellulose and silane is added to the composition. Following 10-15 minutes of agitation, the final composition is then applied at room temperature to a PET based polymer film (side without antistatic treatment), having a surface area of circa 650 cm²-using a Mayer rod wound with 0.175 mm diameter LSB wire; the film is then dried in an oven at 120° C. for 2 minutes.

### Example 58

The release or separation/detachment composition of matter consists of:

1) 0.5 grams of palmitic acid;

2) 0.9 grams of 3-glycidoxypropyltrimethoxysilane;

3) 2.50 grams of trifluoroacetic acid;

4) 2.50 grams of water;

5) 0.6 grams of nano-silica;

6) 0.01 grams of Matexil® DAN dispersing agent;

7) 0.01 grams of Silfoam® SRE antifoam agent;

8) 0.70 grams of methyl cellulose;

9) 0.06 grams of methyl trimethoxy silane;

10) 0.06 grams of methyl triethoxy silane;

11) 3.0 grams of water.

The composition is prepared in the following way:

In a 25 cm³ flask with a magnetic rod, place 0.70 g of methyl cellulose, 0.06 g of methyl trimethoxy silane, 0.06 g of methyl triethoxy silane and 3.0 g of water. Close the flask, agitate and heat to 45-55° C. in a water bath. The composition is left to agitate at 45-55° C. for circa 20-30 minutes then cooled to room temperature under agitation.

In a 25 cm³ flask with a magnetic rod, place 0.50 g of palmitic acid, 0.90 g of 3-glycidoxypropyltrimethoxysilane 2.50 g of trifluoroacetic acid and 2.50 g of water. Close the flask, agitate and heat to 45-55° C. in a water bath. The composition is left to agitate at 45-55° C. for circa 30-40 minutes; the composition is then cooled to room temperature under agitation and 0.6 g of nano-silica, 0.01 g of dispersing agent and 0.01 antifoam agent are added. After 20-30 minutes of agitation, an aqueous solution of methyl cellulose and silane is added to the composition. Following 10-15 minutes of agitation, the final composition is then applied at room temperature to a PET based polymer film, having a surface area of circa 650 cm², using a Mayer rod wound with 0.175 mm diameter LSB wire; the film is then dried in an oven at 120° C. for 2 minutes.

Method for Determining the Release or Separation/Detachment Capacity of the Composition According to the Present Invention (Measurement of the Stripping/Separation/Detachment Force)

To verify and determine the release or separation/detachment capacity of the composition according to the present invention, a dynamometer was used to verify and determine the release/separation/detachment strength of strips of polymeric PET films coated with the release or separation/detachment compositions according to the present invention.

As described in examples, from 1 to 58, all the release or separation/detachment compositions according to the present invention, following preparation and application to the PET polymeric film, as set out therein, the relative release or separation/detachment capacities were determined by means of a methodology designed for this purpose which contemplates the use of a dynamometer (Acquati model AG7E). Said methodology is based on the procedure outlined below and was applied to each PET based polymer film coated with the release or separation/detachment compositions as described in each of Examples 1 to 58. As described, the methodology for determining the release or separation/detachment capacity of the composition subject of this invention is based on the following procedure:

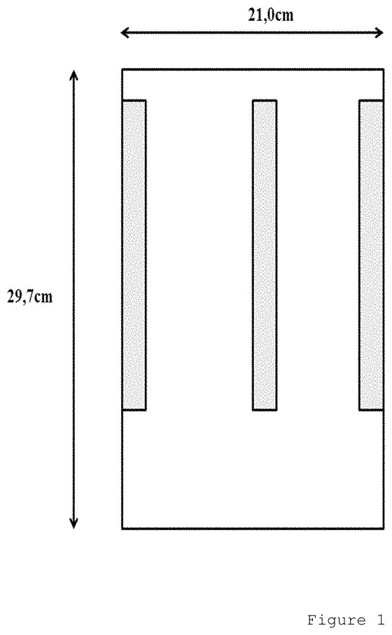

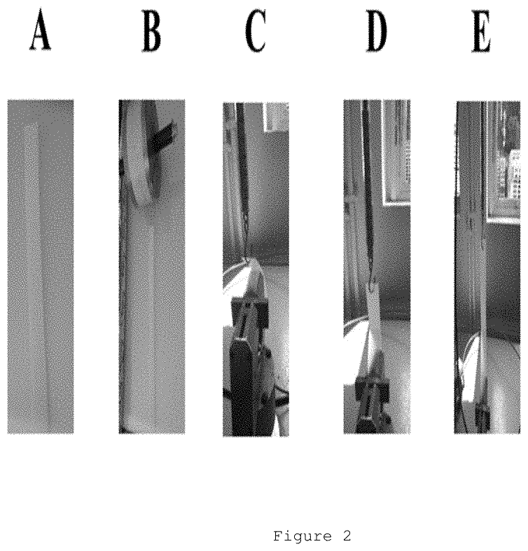

i) from the polymeric PET film, having a surface area of about 650 cm², on which the formulation of the present invention has been applied, according to the methodology described in each example from 1 to 58, three corresponding strips, each measuring 200 mm×20 mm were cut from the right side, the left side and centre of the surface of the coated polymeric film. To this end, see FIG. 1 in which shows this stage of preparing the strips of PET polymer film coated with the composition according to the present invention: the same was performed for each composition as described in each of the examples, from 1 to 58;

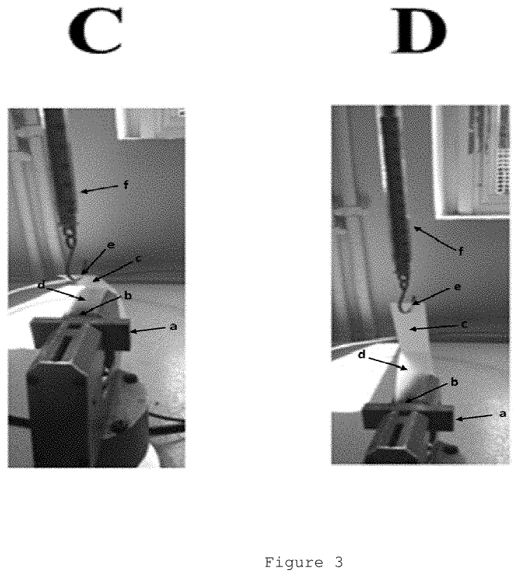

ii) a strip of 3M type 811 adhesive tape (300 mm×19 mm) was applied to each of the three strips removed from the polymer film previously treated with the composition subject of this invention. It was applied in such a manner that a section of a adhesive tape overlapped the surface area of each strip of coated polymer film whose release capacity was to be determined, thus obtaining a specimen for each strip, a specimen with an extra length of adhesive tape to facilitate insertion in fixed jaw of the dynamometer (jaw grip solidly fixed to the machine and the floor): FIG. 2C, FIGS. 3C and 3D, point a)], a tool for measuring the strip/separation/detachment force; this stage of the present method for measuring strip/separation/detachment force of PET film coated with release or separation/detachment composition of matter of the present invention is displayed in FIG. 2A, which shows the application of 3M 811 adhesive tape to the surface of the PET polymer film strip, previously coated with the composition of matter of the present invention; in the coupling, as reproduced in FIG. 2A, between the strip of PET polymer coated with the composition of matter of the invention and the 3M tape, the PET surface coated with the composition of matter of the invention is placed in direct contact with the adhesive surface of the 3M tape.

iii) the strips of polymer film coated and coupled with the adhesive tape, meaning the three specimens obtained for each composition of matter as described and applied onto the PET polymer film of each example from 1 to 58, were pressed with a roller set to 10 kg-no 1 and rolled over the entire length of each specimen—(FIG. 2B); subsequently, the ends of the PET strip coated and coupled with the adhesive tape, said end is that from the side of the 3M adhesive tape overlapping the strip of PET itself, is then manually stripped/separated to a length equal to 30 mm to permit the specimen to be positioned in the dynamometer.

iv) each specimen obtained is inserted in a spring dynamometer, as shown in FIG. 2C and in more detail in FIG. 3C, and a measurement taken for each of these using the dynamometer (FIGS. 2D and 3D). The measurement expects that, as the moving part of the dynamometer attached to the spring begins to move upward at a constant speed, the spring will initially be stretched with the increase in force applied to the PET film attached to it (FIGS. 3C and 3D point e), but will not be stripped/separated until the applied force is sufficient to overcome the adhesion strength between the 3M adhesive tape to the PET film and therefore result in stripping/separation/detachment.

FIG. 3 shows a detail of the test position in the dynamometer (3C) and the start of recording (3D)

a) Dynamometer jaw grip, solidly fixed to the tool and the floor;

b) coupling point of the flap of the 3M tape to the fixed jaw grip;

c) Stripped/unlaminated PET film

d) Stripped/unlaminated 3M tape

e) Coupling point of the flap of the PET film to the spring

f) Spring connected to the moving part of the dynamometer which pulls upwards

The stripping/separation/detachment will proceed, through the upward movement, with almost constant force, of the moving part of the dynamometer and the value of the force taken as the effective measurement of the force is that measured in the instant in which the PET film, following the continuous stripping/separation/detachment, assumes a vertical position in parallel with the spring (FIG. 2E). This force is related to height of the 3M adhesive tape (19 mm or 0.748 inches) and, for each specimen tested, it is the measurement of the stripping/separation/detachment force; for each prepared sample, the measurement is within a range of 0.12-0.16 N/inch (or 0.047-0.063 N/cm or 4.7-6.3 N/m). The indicated range of 0.12-0.16 N/inch (or 0.047-0.063 N/cm or 4.7-6.3 N/m) is an index of an efficient stripping/separation/detachment capacity of the polymeric film treated with the composition of the present invention.

In addition, for all the examples provided, the surface of the release or separation/detachment composition of mater can be printed by means of the usual silk-screening techniques using Plastisol inks, water based Polyurethanes and solvent based Polyurethanes, according to the printing and transfer conditions indicated by the manufacturer for each of these inks; for each of these, moreover, the composition of matter of the present invention provides an optimal release or separation/detachment of the printed ink onto the surface of the polymeric film adopted for both the hot test and cold test.

1. A process of industrial permeographic printing and textile screen-printing for both hot and cold transfer of a graphic image onto fabric comprising:
applying, as a coating to a surface on one side of a polymer film, a release or separation/detachment composition of matter comprising: stearic acid (octadecanoic acid) or one of its mono-, di-, or triglyceride esters in combination with at least one silane selected from the group comprising: N-(2-aminoethyl)-3-aminopropyl trimethoxy silane, N-(2-aminoethyl)-3-aminopropyl trimethoxy silane, 3-amino propyl triethoxy silaneo, N-(2-aminoethyl)-3-aminopropyl methyl dimethoxy silane, 3-aminopropyl trimethoxy silane, 3-ureidopropyl trimethoxy silane, 3-glycidoxypropyl trimethoxy silane, 3-glicydoxypropyl triethoxy silane, 3-glycidoxypropyl methyl diethoxy silane,
providing the graphic image using serigraphic inks, both water and solvent based, directly onto the layer of release or separation/detachment composition of matter which coats the polymer film, and
placing the inks in contact with the polymeric film coated by the layer of release or separation/detachment composition of matter, said layer bearing the inks which constitute the image on the fabric, the inks being transferred to the fabric as a result of the improved release properties of said inks due to the composition of matter.

2. The process according to claim 1, wherein the release or separation/detachment composition of matter further comprises polyvinyl alcohols selected from polyvinyl alcohols with a 70%-100% degree of hydrolysis and a molecular weight between of 10,000 daltons and 100,000 daltons.

3. The process according to claim 2, wherein the polyvinyl alcohols are selected from polyvinyl alcohols with an 85%-100% degree of hydrolysis and a molecular weight between of 27,000 daltons and 70,000 daltons.
